(19) United States
(12) Patent Application Publication
(10) Pub. No.: US 2025/0319535 A1
(43) Pub. Date: Oct. 16, 2025

(54) RECIPROCATING SAW

(71) Applicant: MILWAUKEE ELECTRIC TOOL CORPORATION, Brookfield, WI (US)

(72) Inventors: Christopher M. Didier, Milwaukee, WI (US); David A. Bierdeman, New Berlin, WI (US); Connor M. Temme, Medford, WI (US)

(21) Appl. No.: 19/174,124

(22) Filed: Apr. 9, 2025

Related U.S. Application Data
(60) Provisional application No. 63/633,171, filed on Apr. 12, 2024.
(60) Provisional application No. 63/715,895, filed on Nov. 4, 2024.
(60) Provisional application No. 63/737,941, filed on Dec. 23, 2024.

(51) Int. Cl. B23D 51/16; B23D 49/16

(52) U.S. Cl. CPC B23D 51/161; B23D 49/16

(57) ABSTRACT

A saw including a spindle assembly having a frame and a spindle that reciprocates between a back-dead-center (BDC) to a front-dead-center (FDC) along a spindle axis. The spindle includes a blade connection that defines a connection axis. The saw includes an orbital plate, an eccentric drive member, and a follower engaged with a cam surface on the orbital plate to pivot the frame about a pivot axis. The cam surface includes a high frequency segment occupying less than 180 degrees of a circumference of the cam surface. A displacement of the connection axis relative in a direction perpendicular to the spindle axis is zero at the FDC. A total displacement of the connection axis in the direction perpendicular to the spindle axis occurs during a forward stroke and a reverse stroke. The high frequency segment is configured to displace the connection axis between 80% to 100% of the total displacement.

### CROSS-REFERENCE TO RELATED APPLICATIONS

The application claims priority to U.S. Provisional Patent Application No. 63/737,941, filed Dec. 23, 2024, U.S. Provisional Patent Application No. 63/715,895, filed Nov. 4, 2024, and U.S. Provisional Patent Application No. 63/633,171, filed Apr. 12, 2024, the entire contents of all of which are incorporated by reference herein.

### FIELD OF THE INVENTION

The present invention relates to power tools, and more particularly to reciprocating saws.

### BACKGROUND OF THE INVENTION

Power tools include different types of drive mechanism to perform work. Power tools with reciprocating-type drive mechanisms commonly include counterweights to counterbalance forces generated by output elements (e.g., saw blades) during reciprocating movement. Power tools with orbiting-type drive mechanisms commonly include a sloped surface to pivot the output element.

### SUMMARY OF THE INVENTION

The present invention provides, in one aspect, a reciprocating saw including a housing, an electric motor positioned within the housing and having a motor output shaft rotatable about a motor axis, and a spindle assembly. The spindle assembly includes a spindle frame pivotably coupled to the housing about a pivot joint, the pivot joint defining a pivot axis, and a spindle supported for reciprocation within the spindle frame along a spindle axis oriented perpendicular to the pivot axis. The spindle reciprocates between a back-dead-center (BDC) position to a front-dead-center (FDC) position along the spindle axis. The spindle includes a blade connection portion configured to secure a saw blade. The blade connection portion defines a blade connection axis parallel to the pivot axis. The reciprocating saw includes an orbital plate configured to convert torque from the motor output shaft to reciprocating movement of the spindle. The orbital plate includes a cam surface surrounding a rotational axis of the orbital plate. The reciprocating saw includes an eccentric drive member coupled to the orbital plate for co-rotation therewith. The eccentric drive member has an eccentric portion offset from the rotational axis of the orbital plate. The eccentric portion is coupled to the spindle to impart reciprocating movement thereto in response to rotation of the eccentric drive member and the orbital plate. The reciprocating saw includes a follower coupled to the spindle assembly and engaged with the cam surface on the orbital plate to pivot the spindle frame about the pivot axis in response to rotation of the orbital plate, thereby imparting an orbital motion to the spindle. The cam surface includes a high frequency segment occupying less than 180 degrees of a circumference of the cam surface. A displacement of the blade connection axis in a direction perpendicular to the spindle axis is zero when the spindle is at the FDC position. A total displacement of the blade connection axis in the direction perpendicular to the spindle axis occurs during a forward stroke when the spindle is traveling from the BDC position to the FDC position, and a reverse stroke when the spindle is traveling from the FDC position to the BDC position. The high frequency segment is configured to displace the blade connection axis between 80% to 100% of the total displacement.

The present invention provides, in another aspect, a reciprocating saw including a housing, an electric motor positioned within the housing and having a motor output shaft rotatable about a motor axis, and a spindle assembly. The spindle assembly includes a spindle frame pivotably coupled to the housing about a pivot joint, the pivot joint defining a pivot axis, and a spindle supported for reciprocation within the spindle frame along a spindle axis oriented perpendicular to the pivot axis. The spindle reciprocates between a back-dead-center (BDC) position to a front-dead-center (FDC) position along the spindle axis. The reciprocating saw includes an orbital plate configured to convert torque from the motor output shaft to reciprocating movement of the spindle. The orbital plate includes a cam surface surrounding a rotational axis of the orbital plate. The reciprocating saw includes an eccentric drive member coupled to the orbital plate for co-rotation therewith. The eccentric drive member has an eccentric portion offset from the rotational axis of the orbital plate and an eccentric pin being coupled to the spindle to impart reciprocating movement thereto in response to rotation of the eccentric drive member and the orbital plate. The reciprocating saw includes a follower coupled to the spindle assembly and engaged with the cam surface on the orbital plate to pivot the spindle frame about the pivot axis in response to rotation of the orbital plate, thereby imparting an orbital motion to the spindle. The cam surface includes a high frequency segment spanning a circumference of the cam surface between a first point and a second point. The cam surface includes a low frequency segment spanning a remainder of the circumference of the cam surface. The spindle defines a forward stroke when moving from the BDC position to the FDC position and a reverse stroke when moving from the FDC position to the BDC position. At a first rotational position of the orbital plate, the follower engages the first point. The eccentric pin is angularly offset from the first point at an included angle between-180 and 180 degrees relative to the rotational axis at the first rotational position.

The present invention provides, in another aspect, a reciprocating saw including a housing and an electric motor positioned within the housing and having a motor output shaft rotatable about a motor axis. The reciprocating saw further includes a spindle assembly having a spindle frame pivotably coupled to the housing about a pivot axis and a spindle supported for reciprocation within the spindle frame along a spindle axis oriented perpendicular to the pivot axis. The reciprocating saw further includes a drive mechanism configured to convert torque from the motor output shaft to reciprocating movement of the spindle. The drive mechanism includes a drive pinion coupled for co-rotation with the motor output shaft and a driven gear meshed with the drive pinion and having a cam surface surrounding a rotational axis of the driven gear. The drive mechanism further includes a crankshaft coupled to the driven gear for co-rotation therewith. The crankshaft having a first eccentric portion offset from the rotational axis of the driven gear and a second eccentric portion offset from the rotational axis of the driven gear. The first eccentric portion being coupled to the spindle to impart reciprocating movement thereto in response to rotation of the crankshaft and the driven gear. The reciprocating saw further includes a counterweight coupled to the second eccentric portion of the crankshaft to receive reciprocating movement therefrom in response to rotation of the crankshaft and the driven gear. The reciprocating saw further includes a follower coupled to the spindle assembly and engaged with the cam surface on the driven gear to pivot the spindle frame about the pivot axis in response to rotation of the driven gear, thereby imparting an orbital motion to the spindle. The cam surface defines a continually sloping edge on an outer perimeter of the driven gear. The continually sloping edge includes a first segment and a second segment. The first segment has a first waveform and the second segment has a second waveform that is different from the first waveform.

The present invention provides, in another aspect, a reciprocating saw including a housing, an electric motor positioned within the housing and having a motor output shaft rotatable about a motor axis and a spindle assembly. The spindle assembly includes a spindle frame pivotably coupled to the housing about a pivot joint which defines a pivot axis. The spindle assembly includes a spindle supported for reciprocation within the spindle frame along a spindle axis oriented perpendicular to the pivot axis. The reciprocating saw includes a transmission member configured to receive torque from the motor output shaft, causing the transmission member to rotate about a rotational axis. The reciprocating saw includes an eccentric drive member coupled to the transmission member for co-rotation therewith. The eccentric drive member has an eccentric portion offset from the rotational axis of the transmission member. The eccentric portion is coupled to the spindle to impart reciprocating movement thereto in response to rotation of the eccentric drive member and the transmission member about the rotational axis. The reciprocating saw includes a cam surface surrounding the rotational axis of the transmission member. The reciprocating saw includes a follower coupled to the spindle assembly and engaged with the cam surface to pivot the spindle frame about the pivot axis in response to rotation of the cam surface about the rotational axis, thereby imparting an orbital motion to the spindle. The cam surface includes a first segment and a second segment, the first segment having a first waveform and the second segment having a second waveform that is different from the first waveform.

The present invention provides, in another aspect, a reciprocating saw including a housing, an electric motor positioned within the housing and having a motor output shaft rotatable about a motor axis, and a spindle assembly. The spindle assembly includes a spindle frame pivotably coupled to the housing about a pivot joint, the pivot joint defining a pivot axis. The spindle assembly includes a spindle supported for reciprocation within the spindle frame along a spindle axis oriented perpendicular to the pivot axis. The reciprocating saw includes a transmission member configured to receive torque from the motor output shaft, causing the transmission member to rotate about a rotational axis. The reciprocating saw includes an eccentric drive member coupled to the transmission member for co-rotation therewith, the eccentric drive member being offset from the rotational axis of the transmission member by a distance greater than 0.625 inches and less than or equal to 0.75 inches. The eccentric drive member is coupled to the spindle to impart reciprocating movement thereto in response to rotation of the eccentric drive member and the transmission member about the rotational axis. The reciprocating saw includes a cam surface surrounding the rotational axis of the transmission member. The reciprocating saw includes a follower coupled to the spindle assembly and engaged with the cam surface to pivot the spindle frame about the pivot axis in response to rotation of the cam surface about the rotational axis, thereby imparting an orbital motion to the spindle.

The present invention provides, in another aspect, a reciprocating saw including a housing, an electric motor positioned within the housing and having a motor output shaft rotatable about a motor axis, and a spindle assembly. The spindle assembly includes a spindle frame pivotably coupled to the housing about a pivot joint, the pivot joint defining a pivot axis, and a spindle supported for reciprocation within the spindle frame along a spindle axis oriented perpendicular to the pivot axis. The spindle reciprocates between a back-dead-center (BDC) position to a front-dead-center (FDC) position along the spindle axis. The spindle includes a blade connection portion configured to secure a saw blade. The blade connection portion defines a blade connection axis parallel to the pivot axis. The reciprocating saw includes an orbital plate configured to convert torque from the motor output shaft to reciprocating movement of the spindle. The orbital plate includes a cam surface surrounding a rotational axis of the orbital plate. The reciprocating saw includes an eccentric drive member coupled to the orbital plate for co-rotation therewith. The eccentric drive member has an eccentric portion offset from the rotational axis of the orbital plate. The eccentric portion is coupled to the spindle to impart reciprocating movement thereto in response to rotation of the eccentric drive member and the orbital plate. The reciprocating saw includes a follower coupled to the spindle assembly and engaged with the cam surface on the orbital plate to pivot the spindle frame about the pivot axis in response to rotation of the orbital plate, thereby imparting an orbital motion to the spindle. The cam surface includes a high frequency segment occupying less than 180 degrees of a circumference of the cam surface. A displacement of the blade connection axis in a direction perpendicular to the spindle axis is zero when the spindle is at the FDC position. A forward maximum displacement of the blade connection axis in the direction perpendicular to the spindle axis occurs during a forward stroke when the spindle is traveling from the BDC position to the FDC position. A phase angle of the cam surface at the FDC position is 0 degrees. The phase angle of the cam surface at the BDC position is 180 degrees and the phase angle of the cam surface at the forward maximum displacement is between 200 degrees and 280 degrees.

The present invention provides, in another aspect, a reciprocating saw including a housing, an electric motor positioned within the housing and having a motor output shaft rotatable about a motor axis, and a spindle assembly. The spindle assembly includes a spindle frame pivotably coupled to the housing about a pivot joint, the pivot joint defining a pivot axis, and a spindle supported for reciprocation within the spindle frame along a spindle axis oriented perpendicular to the pivot axis. The reciprocating saw includes a transmission member configured to receive torque from the motor output shaft, causing the transmission member to rotate about a rotational axis. The reciprocating saw includes an eccentric drive member coupled to the transmission member for co-rotation therewith. The eccentric drive member includes an eccentric portion offset from the rotational axis of the transmission member. The eccentric portion is coupled to the spindle to impart reciprocating movement thereto in response to rotation of the eccentric drive member and the transmission member about the rotational axis. The reciprocating saw includes a cam surface surrounding the rotational axis of the transmission member. The reciprocating saw includes a follower coupled to the spindle assembly and engaged with the cam surface to pivot the spindle frame about the pivot axis in response to rotation of the cam surface about the rotational axis, thereby imparting an orbital motion to the spindle. The cam surface includes a first segment and a second segment, the first segment define a first average slope and the second segment defines a second average slope. The first average slope is greater than the second average slope.

Other features and aspects of the invention will become apparent by consideration of the following detailed description and accompanying drawings.

### BRIEF DESCRIPTION OF THE DRAWINGS

FIG. 1 is a side view of a reciprocating saw.

FIG. 2A is a schematic view of a drive mechanism and a spindle assembly for use with the reciprocating saw of FIG. 1.

FIG. 2B is a schematic view of a drive mechanism and a spindle assembly for use with the reciprocating saw of FIG. 1.

FIG. 2C is a cross-section of a drive mechanism and a spindle assembly for use with the reciprocating saw of FIG. 1.

FIG. 3 is a top view an orbital plate for use with the drive mechanisms of FIGS. 2A and 2B, shown at a front dead center position.

FIG. 4 is a cross-sectional view of the orbital plate of FIG. 3, taken along section 4-4 in FIG. 3.

FIG. 5 is a graph of a waveform representing a cam surface of the orbital plate of FIG. 3.

FIG. 6 is a top view the orbital plate of FIG. 3 in a first rotational position.

FIG. 7 is a top view the orbital plate of FIG. 3 in a back dead center position.

FIG. 8 is a top view of the orbital plate of FIG. 3 in a second rotational position.

FIG. 9 is a graph comparing orthogonal dimensions of displacement of a blade connection axis of the reciprocating saw of FIG. 1 using the orbital plate of FIG. 3.

FIG. 10 is a graph comparing orthogonal dimensions of displacement of the blade connection axis of FIG. 9 using prior art orbital plates with a reciprocating saw.

FIG. 11A is a side view of the reciprocating saw of FIG. 1 with the orbital plate of FIG. 3 during the reverse stroke.

FIG. 11B is a side view of the reciprocating saw of FIG. 1 with the orbital plate of FIG. 3 during the forward stroke.

FIG. 11C is a side view of the reciprocating saw of FIG. 1 with the orbital plate of FIG. 3 at the FDC position.

FIG. 12 is a graph of vibration of the reciprocating saw using the orbital plate of FIG. 3 and a prior art orbital plate of FIG. 10.

FIG. 13 is a graph of average duration of cut using orbital plates with different included angles.

FIG. 14 is a graph comparing orthogonal dimensions of displacement of a blade connection axis of the reciprocating saw of FIG. 1 using an orbital plate according to another embodiment.

FIG. 15 is a graph comparing orthogonal dimensions of displacement of a blade connection axis of the reciprocating saw of FIG. 1 using an orbital plate according to another embodiment.

FIG. 16 is a graph comparing orthogonal dimensions of displacement of a blade connection axis of the reciprocating saw of FIG. 1 using an orbital plate according to another embodiment.

FIG. 17 is a graph comparing orthogonal dimensions of displacement of a blade connection axis of the reciprocating saw of FIG. 1 using an orbital plate according to another embodiment.

FIG. 18 is a graph comparing orthogonal dimensions of displacement of a blade connection axis of the reciprocating saw of FIG. 1 using an orbital plate according to another embodiment.

FIG. 19 is a graph comparing orthogonal dimensions of displacement of a blade connection axis of the reciprocating saw of FIG. 1 using an orbital plate according to another embodiment.

FIG. 20 is a graph comparing orthogonal dimensions of displacement of a blade connection axis of the reciprocating saw of FIG. 1 using an orbital plate according to another embodiment.

FIG. 21 is a graph comparing orthogonal dimensions of displacement of a blade connection axis of the reciprocating saw of FIG. 1 using the orbital plate of FIG. 3 with different stroke lengths.

FIG. 22 is a graph comparing spindle linear velocity of the reciprocating saw of FIG. 1 using the orbital plate of FIG. 3 with different stroke lengths.

FIG. 23 is a graph modeling an average duration of cut using the orbital plate of FIG. 3 and a prior art orbital plate of FIG. 10 with the reciprocating saw of FIG. 1 having different stroke lengths.

FIG. 24 is a side view of a blade of the reciprocating saw of FIG. 1 contacting a work piece.

FIG. 25A is a side view of the blade of the reciprocating saw of FIG. 1 having a stroke length of 1.25 inches at the FDC position prior to initiating a cut.

FIG. 25B is a side view of the blade of the reciprocating saw of FIG. 1 having a stroke length of 1.25 inches at the BDC position after a reverse stroke.

FIG. 25C is a side view of the blade of the reciprocating saw of FIG. 1 having a stroke length of 1.25 inches at the FDC position after a forward stroke.

FIG. 26A is a side view of the blade of the reciprocating saw of FIG. 1 having a stroke length of 1.5 inches at the FDC position prior to initiating a cut.

FIG. 26B is a side view of the blade of the reciprocating saw of FIG. 1 having a stroke length of 1.5 inches at the BDC position after a reverse stroke.

FIG. 26C is a side view of the blade of the reciprocating saw of FIG. 1 having a stroke length of 1.5 inches at the FDC position after a forward stroke.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

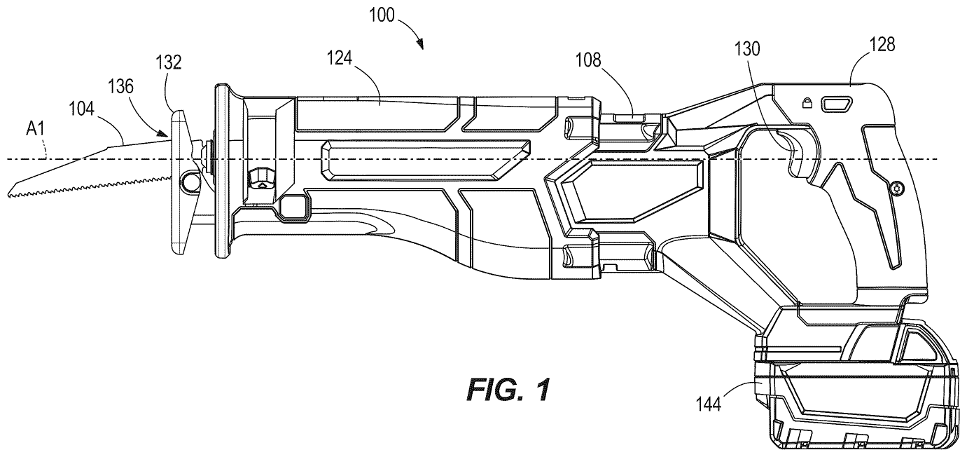

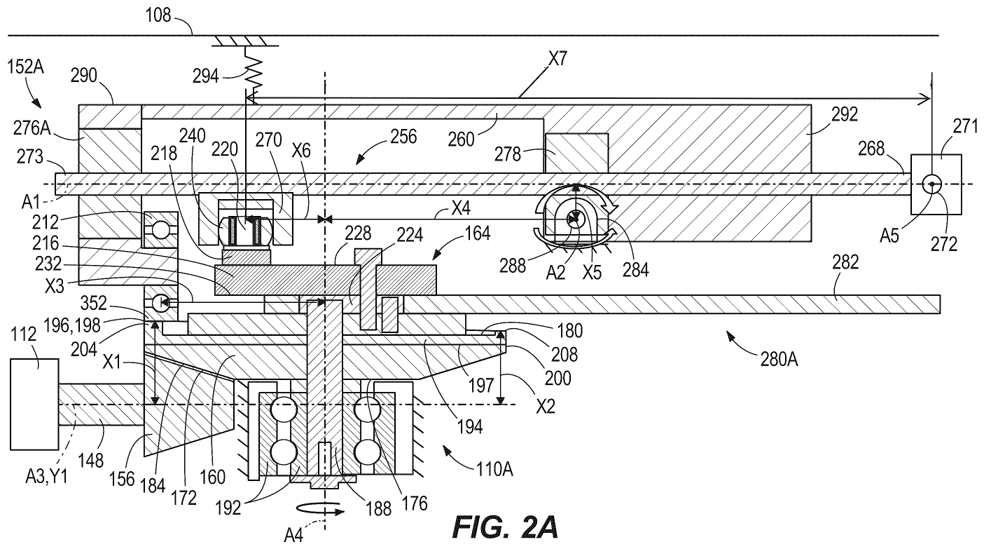

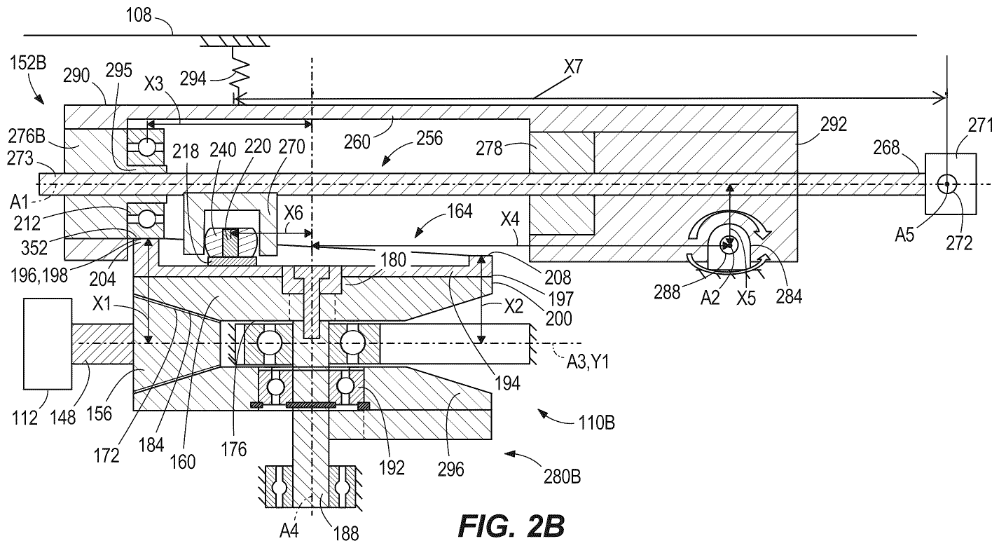

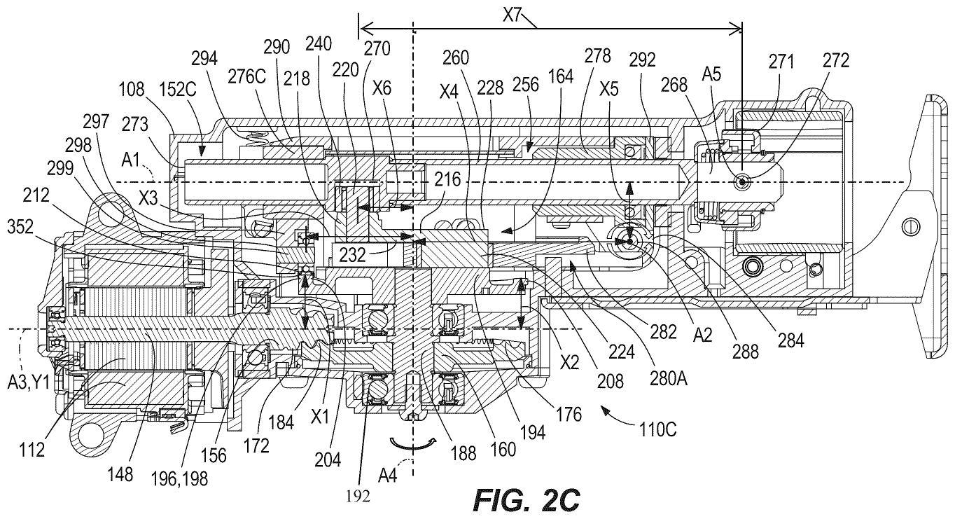

FIG. 1 illustrates a power tool (e.g., a reciprocating saw 100) that is operable to drive a saw blade 104 in an orbiting cutting motion. In the illustrated embodiment, the blade 104 reciprocates along a linear axis or spindle axis A1 while pivoting about a pivot axis A2 (FIG. 2A). The reciprocating saw 100 reciprocates the blade 104 through a fixed stroke length (e.g., 1.25 inches, 1.375 inches, 1.5 inches etc.).

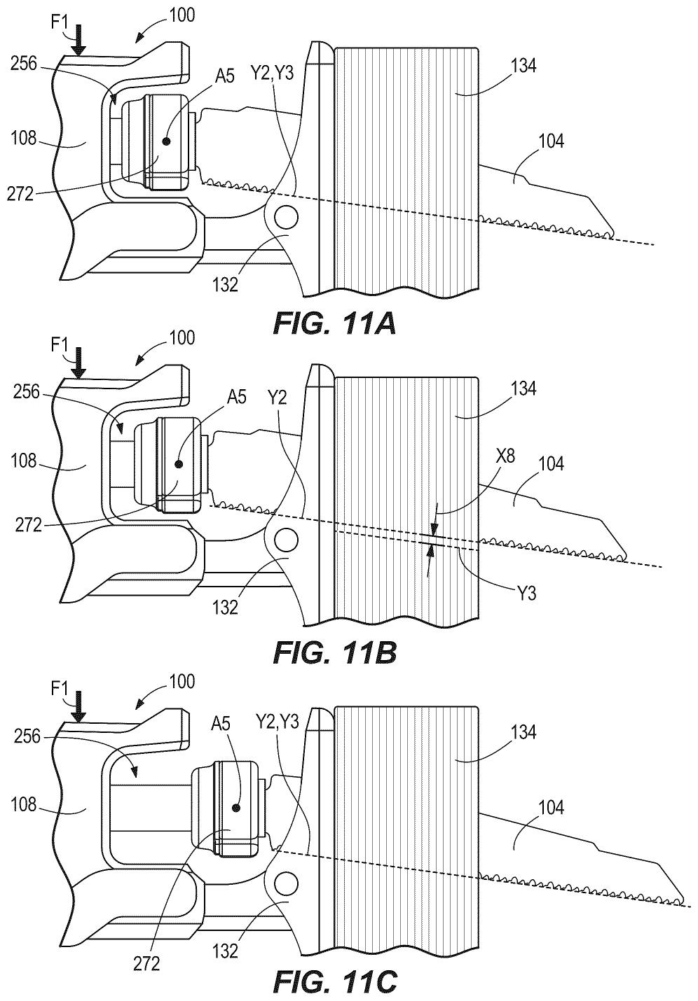

The reciprocating saw 100 includes a housing 108, an electric motor 112 positioned within the housing 108, and a drive mechanism 110A that receives torque from the motor 112 to drive the blade 104 in the reciprocating and orbiting cutting motion described above (FIG. 2A). The saw 100 also includes a grip 124 covering a portion of the housing 108 and a D-shaped handle 128 at the rear of the housing 108, which are both grasped by a user during operation of the reciprocating saw 100. The grip 124 is made from a resilient material (e.g., rubber, silicon, etc.) and extends around a portion of the housing 108. The saw 100 further includes a trigger 130 (e.g., a variable speed trigger) on the handle 128 to be depressed by the user to activate the motor 112. A shoe 132 extends from the housing 108 to abut a workpiece 134 (FIGS. 11A-11C) during a cutting operation. The shoe 132 includes a slot 136 through which the blade 104 extends.

The saw 100 includes a battery receptacle (not shown) below the handle 128. The battery receptacle is configured to receive a battery pack 144. The battery pack 144 may include any of a number of different nominal voltages (e.g., 12V, 18V, etc.), and may be configured having any of a number of different chemistries (e.g., lithium-ion, nickel-cadmium, etc.). In other embodiments, the reciprocating saw 100 may include a power cord such that the motor 112 is powered by an AC power source (e.g., a wall outlet, a portable generator, etc.).

With reference to FIG. 2A, the motor 112 includes a motor output shaft 148 defining a motor axis A3 that, in some instances, is parallel with the spindle axis A1. The drive mechanism 110A includes a drive pinion 156, a driven gear 160 (e.g., a transmission member), and a crankshaft 164. The drive pinion 156 is coupled for co-rotation with the motor output shaft 148 and is meshed with the driven gear 160. In some embodiments, the drive pinion 156 and the driven gear 160 may be spiral bevel gears, but alternatively may be any other type of meshed gear set (e.g., straight bevel gears, etc.).

The driven gear 160 includes a first side 176 and a second side 180 opposite the first side 176. The first side 176 includes a second plurality of teeth 184 meshed with a first plurality of teeth 172 of the drive pinion 156. The driven gear 160 is rotatably supported by an intermediate shaft 188 which, in turn, is supported within the housing 108 by stacked roller members 192 (e.g., roller bearings). The bearings 192 support the intermediate shaft 188 for rotation about an intermediate shaft axis A4 (also the rotational axis of the driven gear 160) that is perpendicular to the motor axis A3. The intermediate shaft 188 is coaxial with the intermediate shaft axis A4. In some embodiments, the intermediate shaft 188 extends through the driven gear 160 to be received into the crankshaft 164 to directly supply torque thereto. In other embodiments, the intermediate shaft 188 terminates at the driven gear 160, and the crankshaft 164 is directly connected (e.g., using fasteners, a key/keyway arrangement, a press fit, etc.) to the second side 180 of the driven gear 160.

With continued reference to FIG. 2A, the second side 180 of the driven gear 160 includes an orbital plate 194 with a cam surface 196 extending around the intermediate shaft axis A4. In the illustrated embodiment, the orbital plate 194 is coupled to the driven gear 160 at an interface 197. In other words, the orbital plate 194 and the driven gear 160 are formed as separate pieces and are joined tother in a post-manufacturing process (e.g., welding, threaded connection, etc.). In other embodiments, the cam surface 196 is integrated with the driven gear 160. In other words, the orbital plate 194 and the driven gear 160 are formed as a single piece. The cam surface 196 defines a continually sloping edge 198 around an outer perimeter 200 of the driven gear 160 sloping between a region of a highest elevation 204 to a region of a lowest elevation 208. The highest elevation 204 is a point on the cam surface 196 that is at a distance X1, which is measured in a direction parallel to the intermediate shaft axis A4 relative to the motor axis A3. The distance X1 is the greatest distance of a point of the cam surface 196 relative to the motor axis A3. The lowest elevation 208 is a point on the cam surface 196 that is at a distance X2, which is measured in a direction parallel to the intermediate shaft axis A4 relative to the motor axis A3. The distance X2 is the smallest distance of a point of the cam surface 196 relative to the motor axis A3. A follower 212 engages and rides along the cam surface 196 to provide a pivoting or orbiting movement to a spindle assembly 152A, described in detail below.

The crankshaft 164 includes a central hub 216, a first eccentric portion 218 extending from a first side 228 of the hub 216, and a second eccentric portion 224 extending from an opposite, second side 232 of the hub 216. As shown in FIG. 2A, the first eccentric portion 218 and a majority of the radial width of the second eccentric portion 224 are located on opposite sides of the intermediate shaft axis A4 at all times. An eccentric pin 220 extends from the first eccentric portion 218 and is received into the spindle assembly 152A to provide reciprocation, described in further detail later. A drive bushing 240 extends around the eccentric pin 220 to allow rotation of the eccentric pin 220 during operation.

As shown in FIG. 2A, the spindle assembly 152A includes a spindle 256 and a spindle frame 260 to support the spindle 256 for reciprocation along the spindle axis A1. The spindle 256 includes a channel 270 in which the drive bushing 240 is received with a loose sliding fit. The channel 270 has a length dimension that is oriented perpendicular to the length of the spindle 256. Therefore, a combination of the spindle 256, including the channel 270, and the first eccentric portion of the crankshaft 164 defines a scotch-yoke mechanism for translating rotational movement of the crankshaft 164 to linear reciprocation of the spindle 256. A blade clamp 271 is attached to a front end 268 of the spindle 256, ensuring that the blade 104 reciprocates in unison with the spindle 256. The blade clamp 271 includes a blade connection aperture 272 that couples the blade 104 to the blade clamp 271. The blade connection aperture 272 defines a blade connection axis A5. The blade connection axis A5 is parallel to the pivot axis A2. An opposite, rear end 273 of the spindle 256 extends through the rear of the spindle frame 260, ensuring that both ends 268, 273 of the spindle 256 are continuously supported by the spindle frame 260 throughout the entire range of motion of the spindle 256. The spindle assembly 152A includes a first bushing 276A and a second bushing 278. In the illustrated embodiment of FIG. 2A, the spindle 256 is supported for reciprocation by the first bushing 276A received by the spindle frame 260 and the second bushing 278 received by the spindle frame 260. In the illustrated embodiment, the spindle frame 260 is constructed in a single part (i.e., a monolithic construction) that receives the first and second bushings 276A, 278. In other constructions, the spindle frame 260 is constructed of multiple parts. For instance, the spindle frame 260 includes a forward bushing carrier that supports the second bushing 278 and a rearward bushing carrier that support the first bushing 276A. That is, the forward bushing carrier and the rearward bushing carrier are separate from one another. In some constructions, the second bushing 278 is pivotably coupled to the pivot shaft 288 and pivotably supports the spindle 254 such that the forward bushing carrier is fixed (e.g., does not pivot).

As illustrated in FIG. 2A, the saw 100 also includes a counterweight 280A that is reciprocated out of phase with the spindle 256 by rotation of the second eccentric portion 224 about the rotational axis A4. The counterweight 280A is an elongated plate 282 that is parallel to the motor axis A3. The counterweight 280A includes a slot sandwiched between the central hub 216 and the driven gear 160 to receive the second eccentric portion 224. The counterweight 280A reciprocates between a forward and a rearward position in response to rotation of the crankshaft 164 by the driven gear 160. In the illustrated construction, the counterweight 280A is reciprocated in a direction parallel to the axis A1. In other words, the counterweight 280A is a translating counterweight. The counterweight 280A provides vibration attenuation to the reciprocating saw 100 by counteracting unbalanced forced caused by the spindle assembly 152A.

With reference to FIG. 2A, the spindle frame 260 is rotatably coupled to the housing 108 by a pivot joint 284. The pivot joint 284 includes a pivot shaft 288 extending through the spindle frame 260 and defining the pivot axis A2. The spindle frame 260 freely rotates about the pivot shaft 288 in response to the interaction of the follower 212 with the cam surface 196 of the driven gear 160. The follower 212 is coupled to the spindle assembly 152A. In the illustrated embodiment, the follower 212 is fixed to a rear portion 290 of the spindle frame 260. In some embodiments, the follower 212 is a roller member that receives the rear portion 290 of the spindle frame 260. In other embodiments, the follower 212 is the rear portion 290 of the spindle frame 260. The follower 212 engages the cam surface 196 about the outer perimeter 200 of the second side 180 of the driven gear 160 as the driven gear 160 is rotated about the shaft axis A4 in a first direction D1. The first direction D1 is be considered counterclockwise when viewing the driven gear from the shaft axis A4 with the spindle frame 260 proximal to the viewer. As the follower 212 engages the cam surface 196 from the highest elevation 204 to the lowest elevation 208, the rear portion 290 of the spindle frame 260 pivots down (e.g., about the pivot shaft 288), thereby causing a front portion 292 of the spindle frame 260 to pivot up since the front portion 292 is disposed on an opposite side of the pivot axis A2. In other words, as the follower 212 engages the cam surface 196 from the highest elevation 204 to the lowest elevation 208, the blade connection axis A5, and therefore the blade 104, rises. As the follower 212 engages the lowest elevation 208 to the highest elevation 204, the rear portion 290 of the spindle frame 260 pivots up (e.g., about the pivot shaft 288), thereby causing the front portion 292 to pivot down. The continuous movement of the follower 212 between the highest elevation 204 and the lowest elevation 208 causes the orbiting motion of the spindle 256 about the pivot shaft 288. A biasing member 294 (e.g., a spring) is coupled to and positioned between the spindle frame 260 and the housing 108 to provide a restoring moment to the spindle frame 260 in a counterclockwise direction about the pivot axis A2.

In operation, the user depresses the trigger 130 on the handle 128 to activate the motor 112. The motor 112 provides torque to the motor output shaft 148, causing it to rotate about the motor axis A3. The drive pinion 156 receives torque from the motor output shaft 148, causing it to rotate and drive the driven gear 160 and the intermediate shaft 188 to rotate about the intermediate shaft axis A4. Torque from the driven gear 160 (or, alternatively, the intermediate shaft 188) is transmitted to the crankshaft 164, causing it to rotate about the intermediate shaft axis A4. With the first eccentric portion 218 being offset from the intermediate shaft axis A4, the spindle 256 is reciprocated by the eccentric pin 220 and the drive bushing 240, which is slidably received in the channel 270. Specifically, the spindle 256 is reciprocated between a back-dead-center (BDC) position and a front-dead-center (FDC) position relative to the spindle frame 260. In the BDC position, the channel 270 is disposed proximal to the motor 112 relative to the FDC position along the spindle axis A1. In the FDC position, the channel 270 is disposed proximal to the pivot joint 284 relative to the BDC position along the spindle axis A1. A forward stroke occurs when the spindle 256 travels form the BDC position to the FDC position. A reverse stroke occurs when the spindle 256 travels from the FDC position to the BDC position. In the illustrated embodiment, the blade 104 is configured to cut a workpiece 134 during the reverse stroke. In other embodiments, the blade 104 is configured to cut the workpiece 134 during the forward stroke. The counterweight 280A is reciprocated by the second eccentric portion 224 which is180-degrees out of phase with the spindle 256, thereby attenuating vibration from the reciprocating spindle 256 and blade 104. Also, as the driven gear 160 rotates, the follower 212 engages the cam surface 196 to continuously pivot the spindle frame 260 about the pivot shaft 288. The simultaneous reciprocating of the spindle 256 by the first eccentric portion 218, and the reciprocating pivoting movement of the spindle frame 260 by the engagement of the follower 212 on the cam surface 196 and restoring force provided by the spring 294 causes the spindle 256 and the attached blade 104 to move in an orbital path. By imparting orbital motion to the blade 104 in this manner, workpiece 134 cutting operations can be performed more efficiently compared to only translating the blade 104 in a reciprocating manner.

FIG. 2B illustrates another embodiment of a drive mechanism 110B and a spindle assembly 152B that is compatible with the reciprocating saw 100. The drive mechanism 110B and the spindle assembly 152B are similar to the drive mechanism 110A and the spindle assembly 152A, respectively, and therefore only differences will be discussed. In the illustrated construction, the spindle assembly 152B includes a bushing 276B having a cylindrical portion 295 that receives the follower 212. In other constructions, the follower 212 is received on the spindle frame 260. With respect to the drive mechanism 110B, the first eccentric portion 218 is received on the orbital plate 194 (i.e., the drive mechanism 110B does not includes the central hub 216 and the second eccentric portion 224). In the illustrated construction, a counterweight 280B includes a gear 296 (e.g., a counterweight gear) that provides vibration attenuation to the reciprocating saw 100 by counteracting unbalanced forced caused by the spindle assembly 152B. The counterweight gear 296 rotates about the axis A4. In the illustrated embodiment, a plane Y1 includes the axis A3 and is perpendicular to the axis A4. The gear 296 is disposed on different side of the plane Y1 than the driven gear 160. In other words, the gear 296 is disposed on an opposite side of the plane Y1 from the driven gear 160.

FIG. 2C illustrates another embodiment of a drive mechanism 110C and a spindle assembly 152C that is compatible with the reciprocating saw 100. The drive mechanism 110C and the spindle assembly 152C are similar to the drive mechanism 110A and the spindle assembly 152A, respectively, and therefore only differences will be discussed. The driven gear 160 is spaced apart from the orbital plate 194. Specifically, the driven gear 160 is disposed on an opposite side of the plane Y1. The orbital plate 194 is coupled for co-rotation with the intermediate shaft 188. The spindle assembly 152C includes a first bushing 276C. The first bushing 276C includes a spindle portion that surrounds the spindle 256 and an auxiliary portion 297 extends from the spindle portion toward the orbital plate 194. Specifically, the auxiliary portion 297 extends parallel to the rotational axis A4. The auxiliary portion 297 includes an aperture 298 extending through the auxiliary portion in a direction parallel to the motor axis A3. The aperture 298 receives a post 299 that receives the follower 212.

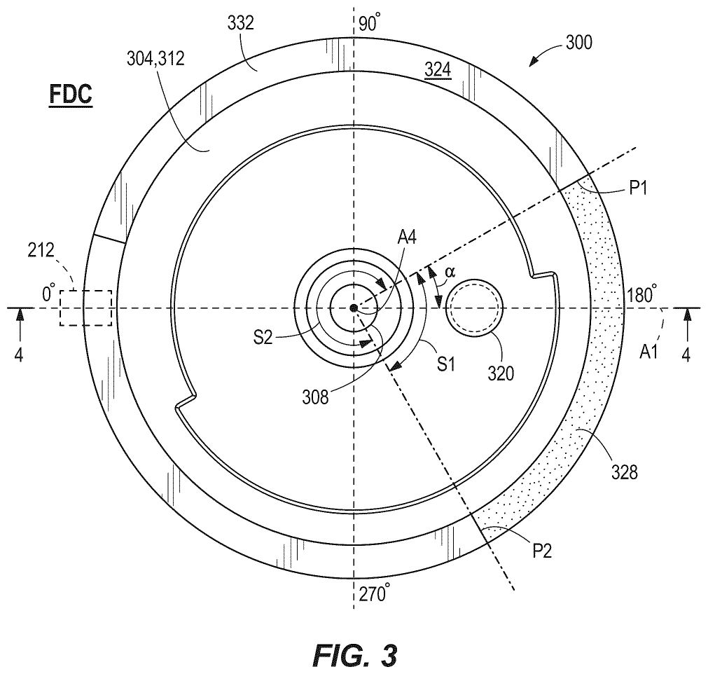

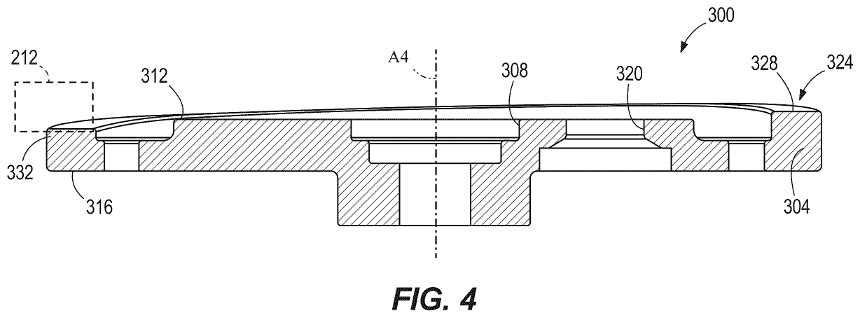

FIGS. 3 and 4 illustrate an orbital plate 300 (e.g., a transmission member) that is compatible with the drive mechanisms 110A and 110B in place of the orbital plate 194 shown in FIGS. 2A and 2B. Specifically, the orbital plate 300 and the driven gear 160 are joined tother in a post-manufacturing process (e.g., welding, threaded connection, etc.). In some embodiments, the saw 100 is a direct drive saw (e.g., no gear reduction). For instance, the motor output shaft 148 is directly coupled to the orbital plate 300 such that the motor axis A3 is perpendicular to the spindle axis A1. The orbital plate 300 is comprised of a body 304 that is monolithic in structure and includes a center aperture 308 that is concentric with the intermediate shaft axis A4. In the illustrated embodiment, the center aperture 308 extends through an entirety of a body 304. As best shown in FIG. 4, the center aperture 308 is a counterbore hole. In the illustrated embodiment, the counterbore hole is disposed on a first side 312 of the body 304, which is opposite a second side 316. In some embodiments, the center aperture 308 is configured to receive a fastener (not shown) to couple the orbital plate 300 to the driven gear 160 at the interface 197 (FIGS. 2A and 2B). In other embodiments, the orbital plate 300 is integrated with the driven gear 160. That is, the features described with respect the orbital plate 300 are integrated into the second side 180 of the driven gear 160.

With reference to FIGS. 3 and 4, the orbital plate 300 includes an aperture 320 disposed radially outward relative to the intermediate shaft axis A4. In the illustrated embodiment, the aperture 320 includes a counterbore hole disposed on the second side 316 of the body 304. The aperture 320 is configured to receive an eccentric drive member (e.g., a fastener, a pin, etc.) that couples the orbital plate 300 to the spindle 256. In some embodiments, a fastener (not shown) couples the orbital plate 300 to the central hub 216 to provide an arrangement as shown in FIGS. 2A and 2B. However, for the sake of simplicity, FIG. 3 schematically illustrates the eccentric pin 220 being received by the aperture 320 such that position of the eccentric pin 220, and therefore the spindle 256, relative to the position of the follower 212 is clearly shown. However, the schematic of FIG. 3 does not limit the orbital plate 300 to be coupled to the eccentric pin 220. Rather, the orbital plate 300 is indirectly attached to the eccentric pin 220. For instance, a non-limiting example of the orbital plate 300 being attached indirectly to the eccentric pin 220 via the central hub 216 as shown in FIG. 2A.

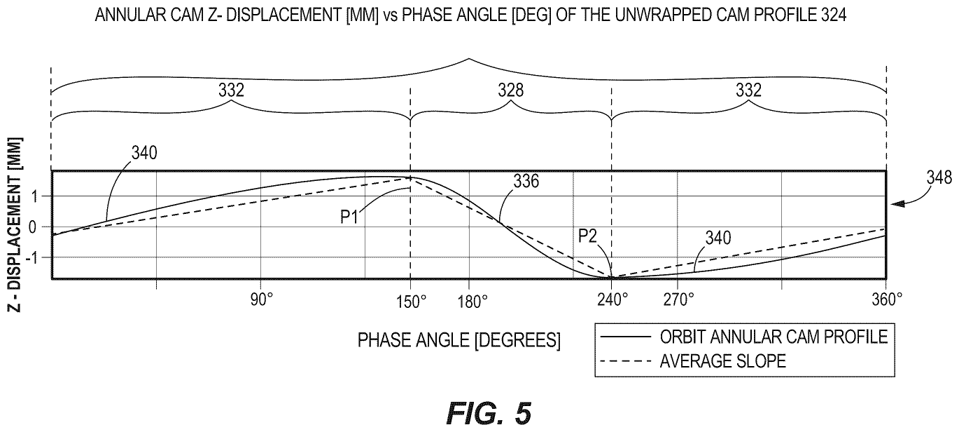

The orbital plate 300 includes a cam surface 324 disposed on an outermost perimeter of the body 304 (e.g., an edge). The cam surface 324 is disposed on the first side 312 of the body 304. The cam surface 324 has a variable profile which is represented as a variable waveform when “unwrapped” as a measure of follower 212 displacement as a function of phase angle of the orbital plate 300. In the illustrated embodiment, the waveform is defined by a first equation over a first range of phase angles of the cam surface 324 (see, for example, first waveform 336 described below and shown in FIG. 5) and a second equation over a second range of phase angles of the cam surface 324 (see, for example, second waveform 340 described below and shown in FIG. 5). In other words, the waveform is a piecewise function. More specifically, the waveform is a piecewise function using two sinusoidal waves. In other embodiments, the waveform is a single polynomial equation (e.g., a B-spline function, a Taylor series approximation, etc.). Specifically, the waveform is a mathematical function that emulates the corresponding piecewise function illustrated in FIG. 5. In each case, the waveforms 336, 340 can be defined with an equation (e.g., a high order polynomial function) or equations (e.g., a piecewise function) relating the displacement of the follower 212 as a function of phase angle of the orbital plate 300.

With reference to FIGS. 3 and 4, the follower 212 is schematically shown and is configured to engage the cam surface 324. As discussed above, the follower 212 pivots about the pivot axis A2 (FIGS. 2A and 2B) during rotation of the orbital plate 300. The cam surface 324 is comprised of first segment 328 and a second segment 332. The first segment 328 defines a first waveform 336 and the second segment 332 defines a second waveform 340 (FIG. 5). As discussed above with respect to the cam surface 196, the cam surface 324 continually slopes from a highest elevation point and a lowest elevation point. The waveforms 336, 340 of the first and second segments 328, 332, collectively, define the continuous slope. That is, the continuous slope is created via the piecewise function of two sinusoidal waves. In the illustrated embodiment, the first waveform 336 is different from the second waveform 340. In other words, the shape of the first segment 328 is different than the shape of the second segment 332. The first segment 328 and the second segment 332 intersect at a first point P1 and a second point P2.

With reference to FIGS. 3 and 4, the orbital plate 300 rotates counterclockwise about the intermediate axis A4 from the frame of reference of FIG. 3. The angular locations of the first and second segments 328, 332 will be described when the eccentric pin 220 is disposed at the FDC position, as shown in FIG. 3. In other words, the angular reference for the orbital plate 300 will be described when the eccentric pin 220 is at the FDC position (i.e., the eccentric pin 220 is at a location closest to the pivot joint 284 along the spindle axis A1). In the FDC position, the eccentric pin 220 is located at 180 degrees and the follower 212 is at 0 degrees. The first segment 328 extends about the cam surface 324 with a first angular span S1. In some embodiments, the angular span S1 is less than 180 degrees. In some embodiments, the angular span S1 is between 50 degrees and 170 degrees. More particularly, in the illustrated embodiment, the first angular span S1 is approximately 90 degrees. The angular span S1 extends from 150 degrees to 240 degrees relative to the intermediate shaft axis A4, measured in a clockwise direction from the frame of reference of FIG. 3. The second segment 332 extends about the cam surface 324 with a second angular span S2. In the illustrated embodiment, the second angular span S2 is approximately 270 degrees. The angular span S2 extends for the remainder of the cam surface 324 relative to the intermediate shaft axis A4. A sum of a first angular span S1 and the second angular span S2 is 360 degrees of the cam surface 324 (e.g., the entire circumference of the cam surface 324).

With reference to FIGS. 3 and 4, the first point P1 is angularly offset from the eccentric pin 220 relative to the intermediate shaft axis A4 at an included angle α. In some embodiments, the included angle is between-180 degrees and 180 degrees. In some embodiments, the included angle α is between-15 and 90 degrees. In the illustrated embodiment, the included angle α is 30 degrees.

FIG. 5 illustrates the cam surface 324 with its continuous sloping edge “unwound” as a waveform. Specifically, waveform is a sinusoidal piecewise function 348. The function 348 is comprised of the combined waveforms 336, 340. The X-axis represents the phase angle (e.g., an angular position of the cam surface 324 from 0 degrees to 360 degrees as shown in FIG. 3). The Y-axis represents the displacement of a surface 352 of the follower 212 as it engages the cam surface 324 (FIGS. 2A and 2B) in a direction parallel to the intermediate shaft axis A4. In other words, the Y-axis represents the elevation or amplitude change of the cam surface 324 relative to a direction parallel to the intermediate shaft axis A4 (e.g., a z-direction).

As illustrated in FIG. 5, the first waveform 336 and the second waveform 340 share a common amplitude. That is, the waveforms 336, 340 share a peak-to-peak value such that they are the same and continuous at the points P1, P2. The first waveform 336, if repeated for the entire 360 degrees of arclength of the cam surface 324, has a higher frequency than the second waveform 340 (if repeated for the entire 360 degrees of arclength of the cam surface 324). For instance, the first waveform 336 extends from peak to peak in an angular span of 90 degrees and the second waveform 340 extends from peak to peak in a span of 270 degrees (FIGS. 3 and 5). As such, the change in elevation in the first segment 328 is more rapid than the change in elevation in the second segment 332.

As shown in FIG. 5, the segments 328, 332 define average slopes with the dashed lines. The average slopes (e.g., M) is equivalent to

$$\frac{{y}_{2} - {y}_{1}}{{x}_{2} - {x}_{1}} .$$

The first segment 328 defines a first average slope M1. The first point P1 is disposed at 150 degrees and approximately 1.8 mm (e.g., x₁=150, y₁=1.8 mm). The second point P2 is disposed at 240 degrees and approximately-1.8 mm (e.g., x₂=240, y₂=−1.8 mm). As such, the first average slope M1 of the first segment 328 is approximately −0.04 mm/degree

$$( e . g . , M 1 = \frac{- 1.8 - 1.8}{90} ) .$$

The second segment 332 defines a second average slope M2. The first point P1 and the second point P2 are at the same location but the second average slope M2 spans from 0 degrees to 150 degrees and from 240 degrees to 360 degrees (i.e., a total of 270 degrees). As such, the second average slope M2 of the second segment 332 is approximately 0.013 mm/degree

$$( e . g . , M 2 = \frac{1.8 - ( - 1.8 )}{270} ) .$$

The magnitude of the first average slope M1 is greater than the magnitude of the second average slope M2. Specifically, the magnitude of the first average slope M1 is between 1.5 times to 4 times greater than the magnitude of the second average slope M2. Specifically, in the illustrated construction, the magnitude of the first average slope M1 (e.g., 0.04 mm/degree) is 3 times the magnitude of the second average slope M2 (e.g., 0.013 mm/degree). In the illustrated construction, the first average slope M1 and the second average slope M2 is taken between peak-to-peak values (e.g., the first point P1 and the second point P2). In contrast to the prior art, the cam surface 324 has two segments 328, 332 that define different slopes from one another. With the prior art orbital plates, there is only a single segment defining a single slope (e.g., a single waveform with a constant frequency).

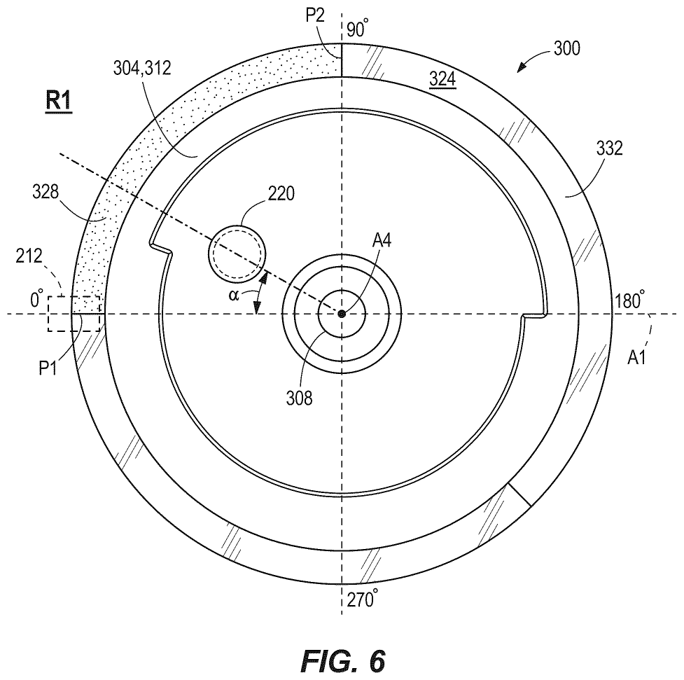

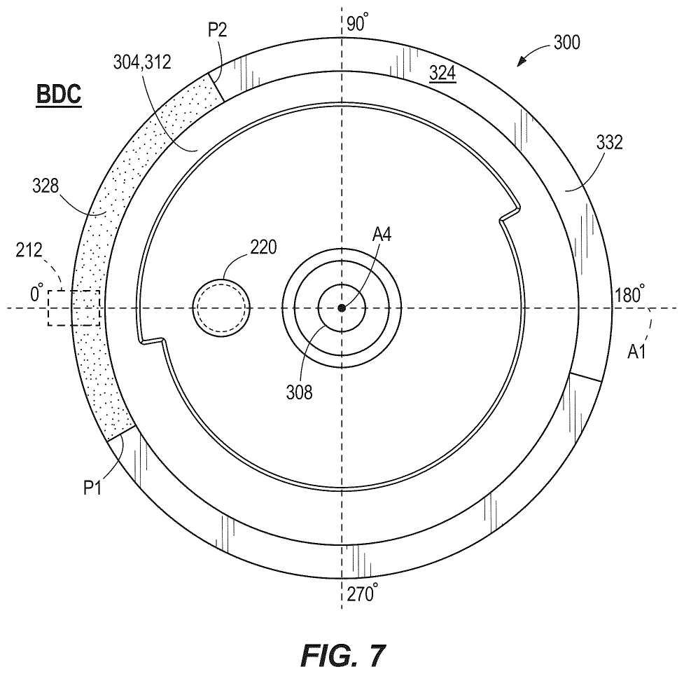

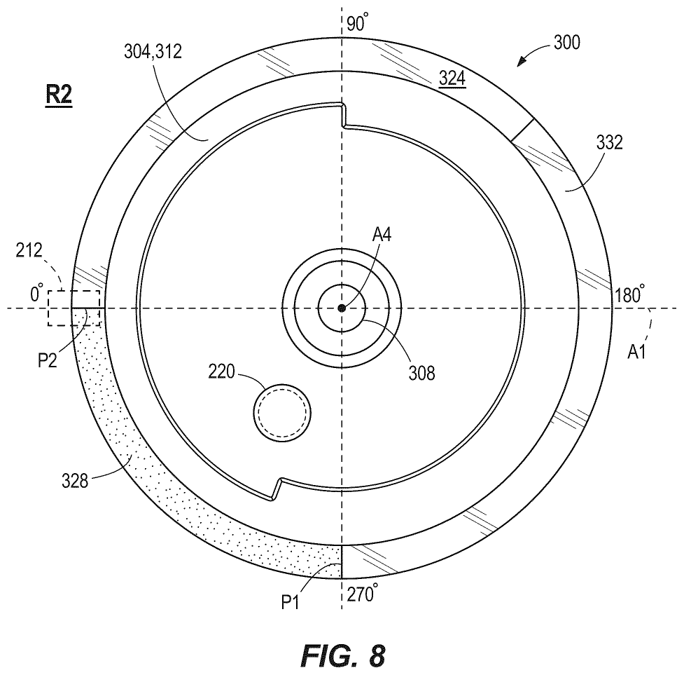

FIGS. 6-8 illustrate the orbital plate 300 at different phase angles with respect to the follower 212 as the orbital plate 300 is rotated about the intermediate shaft axis A4. FIG. 6 illustrates the orbital plate 300 at a first rotational position R1 in which the follower 212 engages the first point P1. FIG. 7 illustrates the orbital plate at the BDC position. FIG. 8 illustrates the orbital plate 300 at a second rotational position R2 in which the follower 212 engages the second point P2. As the follower 212 engages the cam surface 324, the spindle 256 pivots about the pivot axis A2 (FIGS. 2A and 2B).

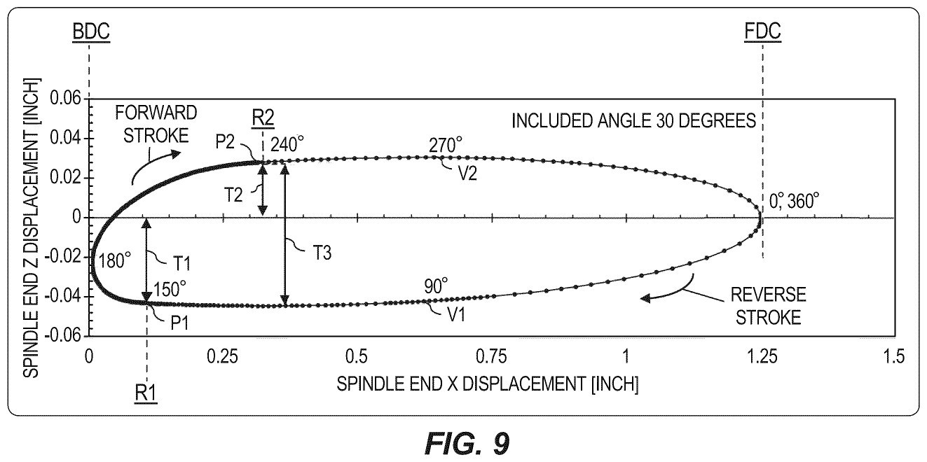

FIG. 9 illustrates a displacement of the blade connection axis A5 for a full 360-degree rotation of the orbital plate 300 about the intermediate shaft axis A4 (including both the forward and reverse strokes of the spindle 256). Specifically, at the FDC position (FIG. 3), a displacement of the blade connection axis A5 is zero measured relative to the pivot axis A2 in a direction parallel to the intermediate shaft axis A4. In other words, the position of the blade connection axis A5 at the FDC position of the spindle 256 is a reference or datum location relative to the forward and reverse strokes (i.e., the displacement of the blade connection axis A5 at FDC position is zero). As illustrated in FIG. 9, the reverse stroke occurs from the FDC position (i.e., 0 degrees) to the BDC position (i.e., 180 degrees). As illustrated in FIG. 9, the forward stroke occurs from the BDC position (i.e., 180 degrees) to the FDC position (i.e., 360 degrees).

With reference to FIG. 5, as the orbital plate 300 is rotated from the FDC position (FIG. 3) to the BDC position (FIG. 7), the blade connection axis A5 is displaced a reverse displacement T1 (e.g., a reverse maximum displacement) during the reverse stroke. Specifically, the reverse displacement T1 is a maximum displacement of the blade connection axis A5 during the reverse stroke relative to the horizontal position of blade connection axis A5 at the FDC position (FIG. 3). In other words, the reverse displacement T1 is a maximum value of the y-axis reached by the blade connection axis A5 during the reverse stroke. In some constructions, the reverse displacement T1 occurs between a phase angle of 110 and 190 degrees. In the illustrated construction, the reverse displacement T1 occurs at a phase angle of 150 degrees. In some embodiments, the reverse displacement T1 of the blade connection axis A5 is between 0.02 inches (e.g., 0.51 millimeters) and 0.06 inches (e.g., 1.5 millimeters). In the illustrated embodiment, the reverse displacement T1 of the blade connection axis A5 is approximately 0.04 inches (e.g., 1 millimeter). In the illustrated embodiment, the blade connection axis A5 is displaced the reverse displacement T1 when the follower 212 engages the first point P1 on the cam surface 324 (FIG. 6). In other words, the first point P1 defines a high point on the cam surface 324 (FIG. 5) coinciding with a low point of the blade connection axis A5 (FIG. 9) relative to the pivot axis A2 in a direction parallel to the intermediate shaft axis A4.

With reference to FIG. 5, as the orbital plate 300 is rotated from the BDC position (FIG. 7) to the FDC position (FIG. 3), the blade connection axis A5 is displaced a forward displacement T2 (e.g., a forward maximum displacement) during the forward stroke. Specifically, the forward displacement T2 is a maximum displacement of the blade connection axis A5 during the forward stroke relative to the horizontal position of the blade connection axis at the FDC position (FIG. 3). In other words, the forward displacement is a maximum value of the y-axis reached by the blade connection axis A5 during the forward stroke. In some constructions, the forward displacement T2 occurs when the phase angle is between 200 degrees and 280 degrees. In the illustrated construction, the forward displacement T2 occurs at a phase angle of 240 degrees. In some constructions, the forward displacement T2 of the blade connection axis A5 is between 0.01 inches (e.g., 0.25 millimeters) and 0.05 inches (e.g., 1.27 millimeters). In the illustrated embodiment, the displacement T2 of the blade connection axis A5 is approximately 0.03 inches (e.g., 0.75 millimeters). In the illustrated embodiment, the blade connection axis A5 is displaced the forward displacement T2 when the follower 212 engages the second point P2 on the cam surface 324 (FIG. 8). In other words, the second point P2 defines a low point on the cam surface 324 (FIG. 5) coinciding with a high point of the blade connection axis A5 (FIG. 9) relative to the pivot axis A2 in a direction parallel to the intermediate shaft axis A4. A total displacement T3 of the blade connection axis A5 is a sum of the reverse and forward displacements T1, T2. In some constructions, the total displacement is between 0.03 inches (e.g., 0.7 millimeters) and 0.11 inches (e.g., 2.8 millimeters). In the illustrated construction, the total displacement T3 is approximately 0.07 inches (e.g., 1.75 millimeters).

FIG. 9 illustrates that from the first rotational position R1 (FIG. 6) to the second rotational position R2 (FIG. 8), the blade connection axis A5 is displaced the total displacement T3. Conversely, the blade connection axis A5 is displaced the total displacement T3 when moving from the second rotational position R2 (FIG. 8) to the first rotational position R1 (FIG. 6). In other words, the blade connection axis A5 experiences the same displacement in the first and second segments 328, 332. However, the first segment 328 occupies 90 degrees of the total arclength of the cam surface 324 and the second segment 332 occupies 270 degrees of the total arclength of the cam surface 324 (e.g., the first segment 328 is a third of the angular span S2 of the second segment 332). The first segment 328 achieves the same displacement of the second segment 332 in a smaller angular span due to the higher frequency of the first waveform 340 (FIG. 5). In some embodiments, the displacement experienced by the blade connection axis A5 in the first segment 328 is not the total displacement T3. In other words, the displacement experienced by the blade connection axis A5 in the first segment 328 is not the same as the displacement experienced in the second segment 332. In such embodiments, the first segment 328 displaces the blade connection axis A5 between 80% to 100% of the total displacement T3.

The displacements T1, T2 of the blade connection axis A5 are dependent upon the dimensions of the saw 100. For instance, as shown in FIGS. 2A and B, a distance X3 measured from the follower 212 to the intermediate shaft axis A4, a distance X4 measured between the pivot axis A2 and the intermediate axis A4, a distance X5 measured between the spindle axis A1 and the pivot axis, a distance X6 measured between the eccentric pin 220 and the intermediate shaft axis A4 and a distance X7 measured between the blade connection axis A5 and the eccentric pin 220, each influence the displacement of the blade connection axis A5 relative to the pivot axis A2. In the illustrated embodiment, the distance X3 is approximately 1.3 inches (e.g., 33 millimeters), the distance X4 is approximately 2.5 inches (e.g., 65 millimeters), the distance X5 is approximately 0.7 inches (e.g., 17 millimeters), the distance X6 is approximately 0.625 inches (e.g., 15.88 millimeters), and the distance X7 is approximately 5 inches (e.g., 128.91 millimeters). In some constructions, the distance X6 is between 0.625 inches and 0.75 inches. Therefore, the total displacement T3 of the blade connection axis A5 is merely a representation of the displacement of the follower 212 due to the cam surface 324 (FIG. 5). In addition to the displacements T1, T2, the slope (e.g., the first average slope M1 and the second average slope M2) is dependent upon the dimensions of the saw 100.

FIG. 9 illustrates that starting from the FDC position, the blade connection axis A5 is gradually lowered from the FDC position to the first rotational position R1 position during the reverse stroke, thereby progressively engaging the teeth of the saw blade with the workpiece 134. From the first rotational position R1 to the second rotational position R2, the blade connection axis A5 is rapidly risen due to the engaging the first segment 328 (e.g., the first point P1) with the first waveform 340. The first segment 328 is disposed on the cam surface 324 such that the rapid rise does not occupy a majority of the reverse stroke. In other words, the majority of the reverse stroke is reserved for the lowering of the blade connection axis A5. Additionally, the rapid rise causes the blade 104 to be lifted aggressively out of the workpiece 134 proximal to the BDC position such that the blade 104 does not catch the workpiece 134 on the forward stroke, thereby preventing kickback. For instance, if the blade 104 was not pulled out from the workpiece 134 prior to the BDC position, the forward stroke begins and results in tool kickback to the user. From the second rotational position R2 to the FDC position, the blade connection axis A5 is gradually dropped coinciding with lowering the saw blade back toward the workpiece 134. The blade 104 is lowered from the second rotational position R2 to the first rotational position R1.

FIG. 9 also illustrates a first maximum velocity V1 and a second maximum velocity V2. The first maximum velocity V1 occurs during the reverse stroke and the second maximum velocity V2 occurs during the forward stroke. Both the velocities V1, V2 are disposed at the midpoint between the FDC position and the BDC position (i.e., the first maximum velocity V1 is at 90 degrees and the second maximum velocity is at 270 degrees on the cam surface).

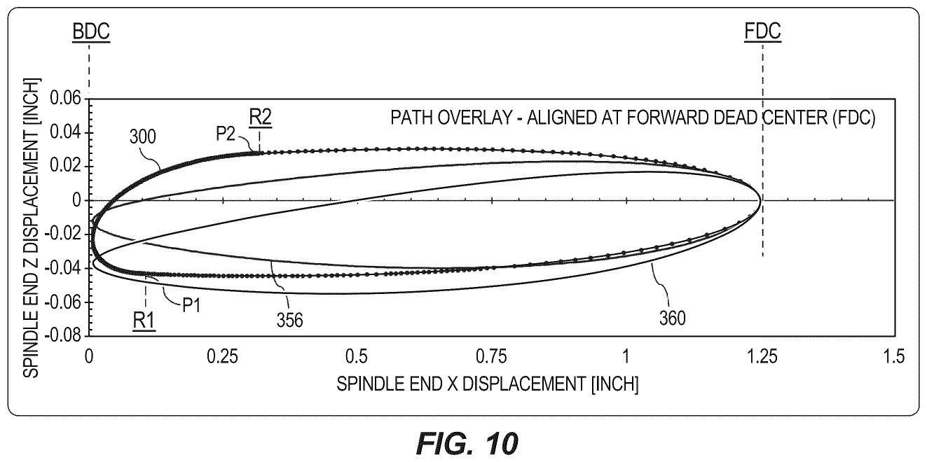

FIG. 10 illustrates the displacement of the blade connection axis A5 in relation to the orbital plate 300, a first prior art orbital plate 356, and a second prior art orbital plate 360. The orbital plate 356 includes a cam surface (not shown) with a single waveform across the 360-degree arclength of the cam surface (and therefore defines a single frequency). The displacement of the blade connection axis A5 for the orbital plate 356 was measured using the saw 100 having the same distances X3-X7 as recorded with the orbital plate 300. The orbital plate 360 includes a cam surface (not shown) with a single waveform across the 360-degree arclength of the cam surface (and therefore defines a single frequency). In the illustrated embodiment, the frequency of the cam surface of the orbital plate 360 is approximately the same as the frequency of the cam surface of the orbital plate 356. However, displacement of the blade connection axis A5 for the orbital plate 360 was measured with the saw 100 having different distances X3-X7. Specifically, the saw 100 used with the orbital plate 360 has the distance X3 being approximately 1.3 inches (e.g., 32.75 millimeters), the distance X4 being approximately 2.6 inches (e.g., 67.5 millimeters), the distance X5 being approximately 0.50 inches (e.g., 13.5 millimeters), the distance X6 being approximately 0.63 inches (e.g., 15.88 millimeters), and the distance X7 being approximately 5 inches (e.g., 126.7 millimeters). The orbital plate 360 illustrates the influence of the distances X3-X7 on the displacement of the orbital plate 360. The rising of the blade connection axis A5 for the orbital plates 356, 360 takes around 180 degrees in contrast to the orbital plate 300 taking 90 degrees (i.e., the first segment 328).

The timing of raising and lowering the blade connection axis A5 (and therefore changing the inclination of the blade 104 relative to the workpiece 134 being cut) affects the efficiency of the cut (e.g., time to complete the cut). The blade 104 is configured to cut a workpiece 134 during the reverse stroke. For instance, the blade 104 includes teeth with serrated edges shaped to cut the workpiece 134 during the reverse stroke. Lowering the blade 104 during the reverse stroke increases the efficiency of the cut because the blade 104 is displaced toward the workpiece 134. As discussed above with respect to FIG. 9, the blade connection axis A5 is gradually lowered from the FDC position to the first rotational position R1 position during the reverse stroke when using the orbital plate 300. In contrast, when using the orbital plate 356, the blade connection axis A5 starts to rise approximately when the spindle end displacement is at 0.6 inches in the x-direction during the reverse stroke (e.g., midway between the FDC position and the BDC position). When using the orbital plate 360, the blade connection axis A5 starts to rise approximately midway when the spindle end displacement is at 0.5 inches in the x-direction during the reverse stroke. In other words, the blade connection axis A5 beings to rise earlier during the reverse stroke when using plates 356, 360 compared to the plate 300. Since the rise of the blade connection axis A5 begins earlier for the plates 356, 360, less of the reverse stroke is displaced toward the workpiece 134 and the efficiency of the cut decreases (e.g., increasing time to cut).

The timing of raising and lowering the blade connection axis A5 (and therefore changing the inclination of the blade 104 relative to the workpiece 134 being cut) also affects the vibration felt by the user. As discussed immediately above, blades for the reciprocating saw 100 are configured to cut on the reverse stroke and do not cut into the workpiece 134 during the forward stroke. Contact of the blade 104 with the workpiece 134 during the forward stroke results in vibration of the saw 100 since the saw 100 is pushed away from the workpiece 134 due to lack of a cut. Contact of the blade 104 with the workpiece 134 may occur near to the BDC position because the blade 104 is not pulled out of the workpiece 134 quick enough. As discussed above with respect to FIG. 9, the blade 104 is lifted aggressively out of the workpiece 134 proximal to the BDC position due to the high frequency of the first segment 328 that occupies 90 degrees of the total arclength of the cam surface 324. The rapid rise of the first segment 328 ensures that the blade 104 is cleared from the workpiece 134. In contrast, when using the orbital plates 356, 360, the blade connection axis A5 is lifted from the workpiece 134 at a more gradual rate. This is because the orbital plates 356, 360 have a lower frequency for rising the blade 104 than the plate 300. Therefore, the blade 104 is less prone to contact the workpiece 134 near BDC position when using the plate 300 because the blade 104 is lifted more aggressively from the workpiece 134 than when using the plates 356, 360. As such, the saw 100 vibrates less when using the plate 300 compared to using the plates 356, 360.

In addition to preventing contact near the BDC position, lifting the blade 104 from cutting the workpiece 134 influences the timing of when the blade 104 next contacts the workpiece 134. FIGS. 11A-11C illustrate the plate 300 being used in the saw 100. FIG. 11A illustrates the blade 104 cutting the workpiece 134. The blade 104 defines a tooth plane Y2 that cuts the workpiece 134 at a cutting plane Y3. Specifically, FIG. 11A illustrates the saw 100 between the FDC and the first rotational position R1 during the reverse stroke. In other words, the blade 104 is cutting the workpiece 134 in FIG. 11A. The tooth plane Y2 is in contact with the cutting plane Y3 because the blade 104 is being pressed toward the cutting plane Y3 by an external force F1. In some constructions, the external force is a combination of the user pressing the saw 100 against the workpiece and gravity.

FIG. 11B illustrates the blade 104 between the BDC position and the FDC position. As shown in FIG. 11B, the tooth plane Y2 is separated from the cutting plane Y3 at a distance X8. Separation occurs between the tooth plane Y2 and the cutting plane Y3 because the housing 108 moves upward due to the tilt of the blade 104 relative to the housing 108 and the downward motion of the blade 104 during the cutting motion (between FDC position and the first rotational position R1). Additionally, the rapid rise of the blade connection axis A5 and the blade 104 due to the first segment 328 contributes to the separation. During the forward stroke, the distance X8 between the planes Y2, Y3 decreases as the external force F1 directs the saw 100 toward the workpiece 134. The separation between the planes Y2, Y3 prevents the blade 104 from contacting the workpiece 134 during the forward stroke, thereby decreasing vibration.

FIG. 11C illustrates the blade 104 at FDC position. The tooth plane Y2 is configured to first contact the cutting plane Y3 at the FDC position such that the blade 104 begins cutting the workpiece 134 from the beginning of the reverse stroke, thereby maximizing contact time between the tooth plane Y2 and the cutting plane Y3. In other words, landing the tooth plane Y2 on the cutting plane Y3 at FDC position increase cutting efficiency since the contact time between the tooth plane Y2 and the cutting plane Y3 is greatest. In an instance where the distance X8 of the separation is too large, the tooth plane Y2 will first contact the cutting plane Y3 between FDC position and BDC position during the reverse stroke, resulting in less contact time between the tooth plane Y2 and the cutting plane Y3 (i.e., decreased cutting efficiency). The concept of the tooth plane Y2 contacting the cutting plane Y3 between the FDC position and the BDC position during the reverse stroke will be referred to as “overshooting” the cutting plane Y3. In an instance where the distance X8 of the separation is too small, the tooth plane Y2 will first contact the cutting plane Y3 before the FDC position during the forward stroke, resulting increased vibration due to the blade 104 contacting the workpiece 134 during the forward stroke. The concept of the tooth plane Y2 contacting the cutting plane Y3 before the spindle 256 reaches the FDC position during the forward stroke will be referred to as “undershooting” the cutting plane Y3.

Accordingly, managing the distance X8 of the separation between the planes Y2, Y3 influences the vibration and efficiency of the cut of the tool. In the instance that the plates 356, 360 are used in the saw 100, the distance X8 would be smaller than when using the plate 300 because the plates 356, 360 do not have an abrupt rise of the blade (FIG. 10). Due to the smaller distance X8 caused by the plates 356, 360, the saw 100 is prone to increased vibration due to the blade contacting the workpiece 134 prior to the FDC position (e.g., undershooting the cutting plane Y3).

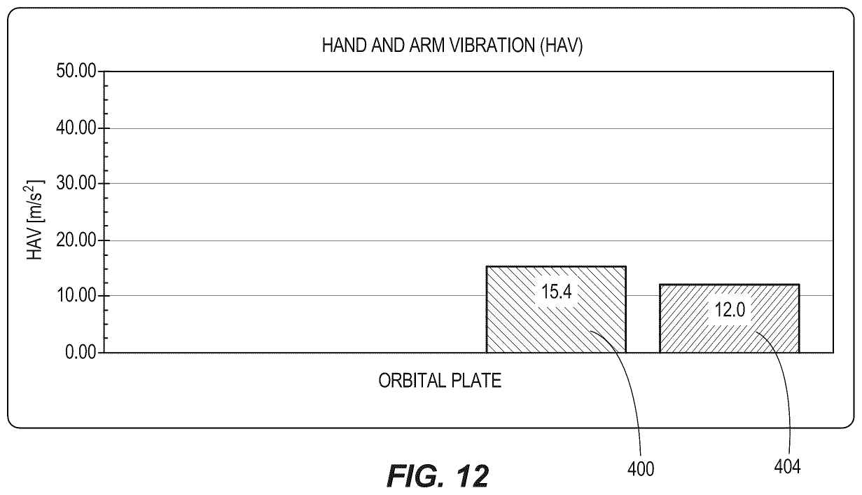

FIG. 12 illustrates the vibration experienced by the saw 100 with the plates 300, 356. Specifically, the vibration illustrated in FIG. 12 is hand and arm vibration (HAV). As shown in FIG. 12, the vibration was measured using acceleration

$$( e . g . , \frac{m}{{s}^{2}} ) .$$

The bar 400 illustrates the saw the saw 100 with the plate 356 and the acceleration was approximately

$$15.4 \frac{m}{{s}^{2}} .$$

The bar 404 illustrates the saw 100 with the plate 300 and the acceleration was approximately

$$12 \frac{m}{{s}^{2}} .$$

As discussed above, the decreased vibration of the saw 100 with the plate 300 can be attributed to the high frequency segment. Without the high frequency segment, the blade 104 may catch on the workpiece 134 near to the BDC position when being lifted from the workpiece 134 or may contact the workpiece 134 prior to the FDC position due to insufficient separation between the planes Y2, Y3.

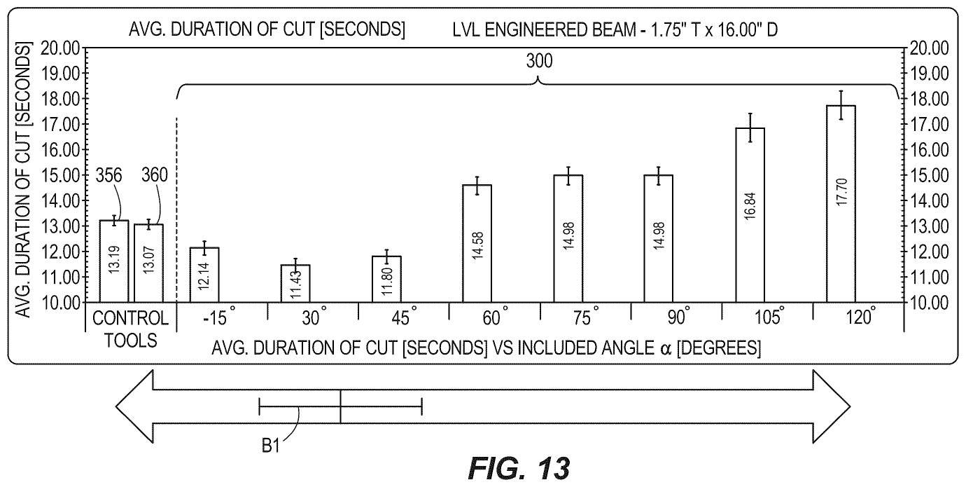

FIG. 13 illustrates an average duration of cut (in seconds) of the saw 100 with variations of the orbital plate 300 having different included angles α. As shown in FIG. 13, the angles of the included angles α range between −15 degrees and 120 degrees (e.g., −15 degrees, 30 degrees, 45 degrees, 60 degrees, 75 degrees, 90 degrees, 105 degrees, and 120 degrees) were recorded. The plates 356 and 360 are included to provide a comparison to the prior art having a single frequency. The duration of the cut was measured by recording the current of the saw 100 while cutting a workpiece (not shown) with a uniform thickness. For the test, a workpiece with a thickness of 1.75 inches and a depth of 16 inches was used. The current of the saw 100 spikes from a no-load condition (i.e., not contacting a work piece) to a load condition (i.e., contacting a workpiece) when initiating the cut. The initial spike in current is recorded as the start time of the cut. When the saw 100 finishes the cut, the motor 112 is unloaded and therefore no longer needs to draw a high current to continue rotating. The reduction in current is detected as the end time of the cut. As such, the duration of the cut is measured from the initial spike in current to the reduction in current.

As shown in FIG. 13, the orbital plate 356 averaged an average cut time of 13.19 seconds. The orbital plate 360 averaged about 13.07 seconds. For the plate 300, the included angle α of −15 degrees averaged 12.14 seconds, the included angle α of 30 degrees averaged 11.43 seconds, the included angle α of 45 degrees averaged 11.80 seconds, the included angle α of 60 degrees averaged 14.58 seconds, the included angle α of 75 degrees averaged 14.98 seconds, the included angle α of 90 degrees averaged 14.98 seconds, the included angle α of 105 degrees averaged 16.48 seconds, and the included angle α of 120 degrees averaged 17.70 seconds.

As shown in FIG. 13, the shortest cutting durations of the workpiece occur when the included angle α of the orbital plate 300 is in a range B1. In some embodiments, the range B1 extends from −15 degrees to 60 degrees. In the illustrated embodiment, the range B1 extends from 20 degrees and 50 degrees. Specifically, in the illustrated embodiment, the shortest average duration of cut occurs at the included angle α of 30 degrees. However, it is worth noting that the range B1 may differ based on the distances X3-X7 of the saw. For instance, with distances other than the distances X3-X7 recorded with the orbital plate 300, the range B1 has included angles α less than 30 degrees or greater than 30 degrees. That is, the range B1 has included angles α between −180 degrees and 180 degrees.

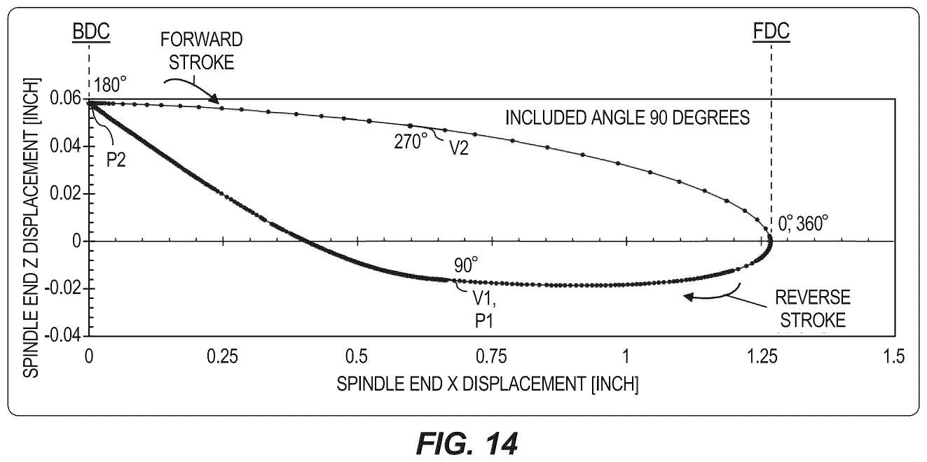

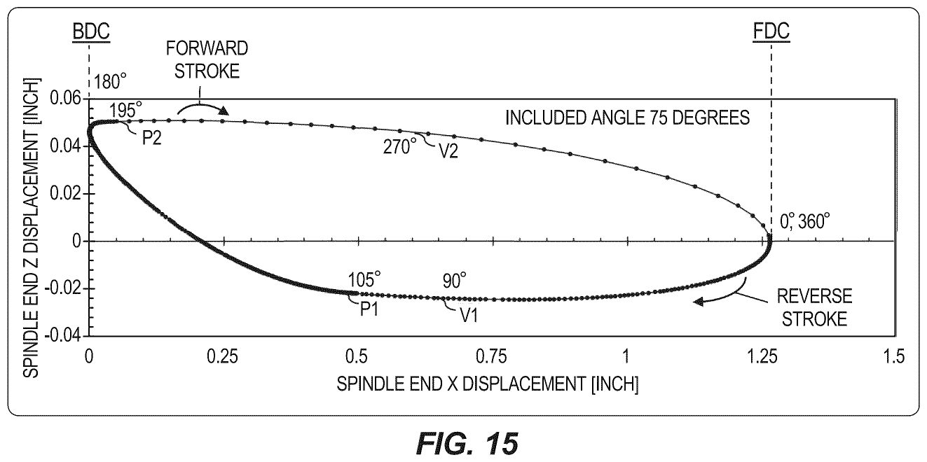

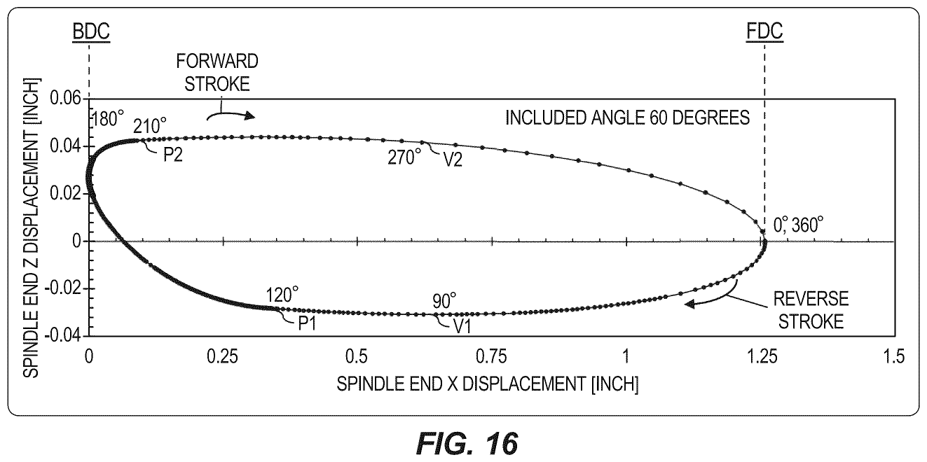

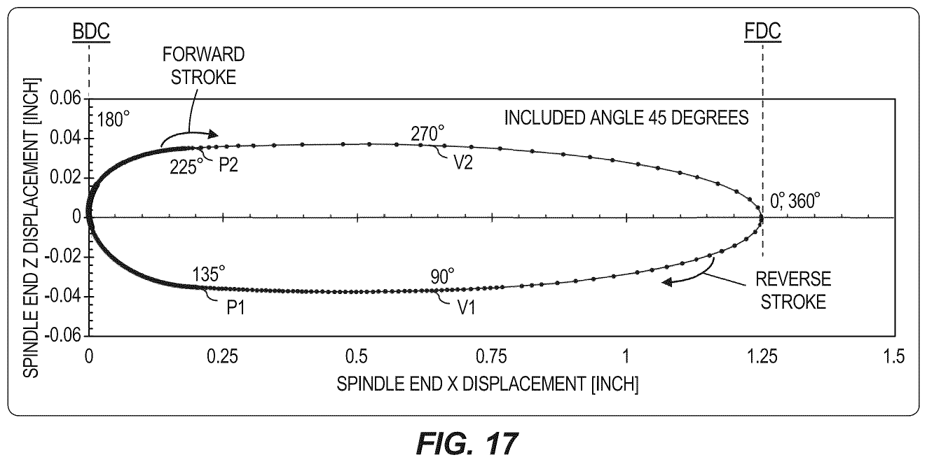

In the illustrated embodiment, the average duration of cut increases when increasing the included angle α from 30 degrees (e.g., when the range B1 is between 30 degrees and 180 degrees). FIGS. 14-17 each illustrate a displacement of the blade connection axis A5 for a full 360-degree rotation of the orbital plate 300 about the intermediate shaft axis A4 (including both the forward and reverse strokes of the spindle 256) with varying included angles α of the orbital plate 300. FIG. 14 illustrates the orbital plate 300 having the included angle α of 90 degrees. FIG. 15 illustrates the orbital plate 300 having the included angle α of 75 degrees. FIG. 16 illustrates the orbital plate 300 having the included angle α of 60 degrees. FIG. 17 illustrates the orbital plate 300 having the included angle α of 45 degrees.

Compared to the included angle α of FIG. 9 (i.e., 30 degrees), the included angles α of FIGS. 14-17 (i.e., 90 degrees, 75 degrees, 60 degrees, and 45 degrees) cause the blade connection axis A5 to rise earlier in the reverse stroke which results in less cutting time and increases the average duration of the cut. The blade connection axis A5 begins to rise when engaging the first segment 328, which is illustrated between the first point P1 and the second point P2. That is, the blade connection axis A5 starts to rise at the first point P1. As shown in FIGS. 14-17, the first point P1 is disposed at an angular location further from the BDC position than illustrated in FIG. 9, which means the blade connection axis A5 rises earlier in the reverse stroke. Also, varying the included angle α to be greater than 30 degrees may cause the tooth plane Y2 to undershoot the cutting plane Y3 since the blade 104 is being lifted earlier, which results in increased vibration.

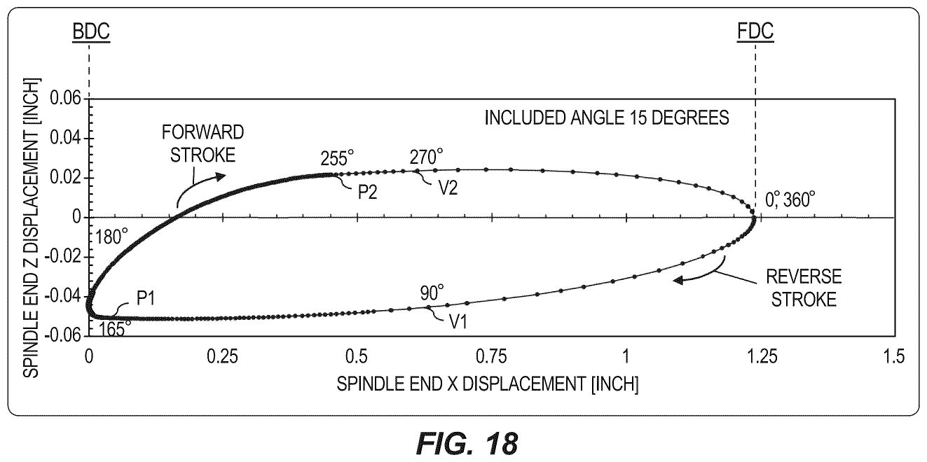

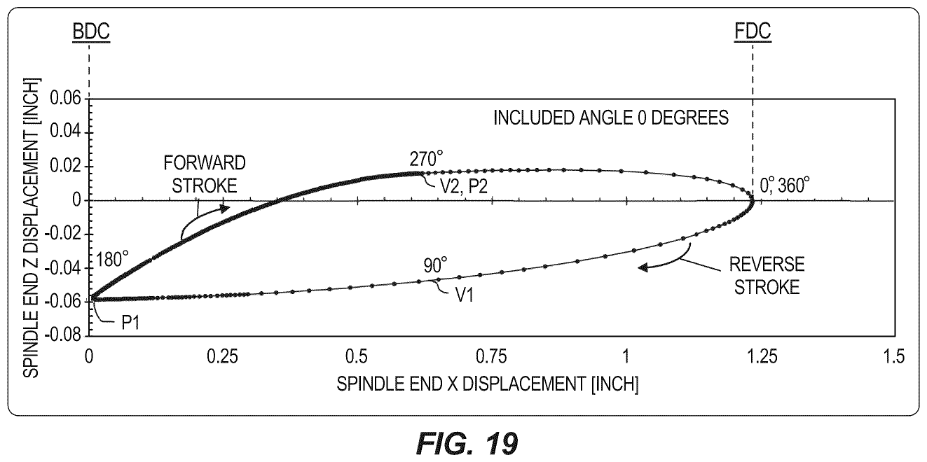

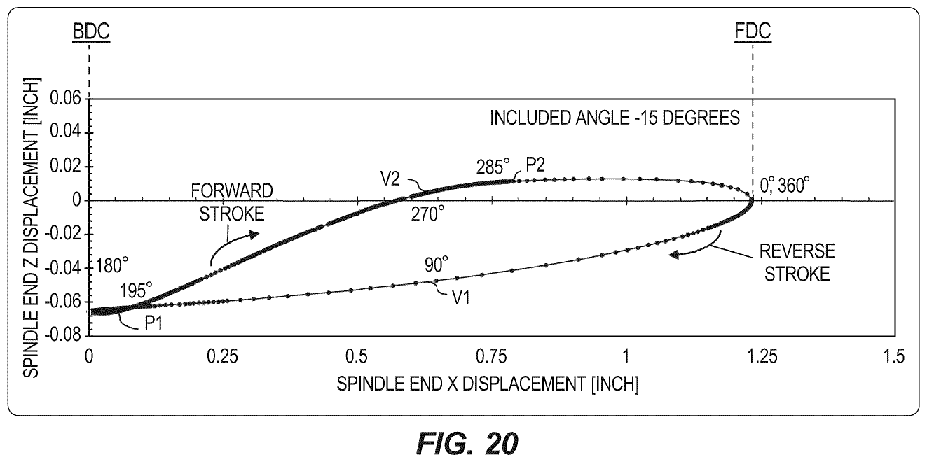

In the illustrated embodiment, the average duration of cut increases when decreasing the included angle α from 30 degrees (e.g., when the range B1 is between-180 degrees and 30 degrees). FIGS. 18-20 each illustrate a displacement of the blade connection axis A5 for a full 360-degree rotation of the orbital plate 300 about the intermediate shaft axis A4 (including both the forward and reverse strokes of the spindle 256) with varying included angles α of the orbital plate 300. FIG. 18 illustrates the orbital plate 300 having the included angle α of 15 degrees. FIG. 19 illustrates the orbital plate 300 having the included angle α of 0 degrees. FIG. 20 illustrates the orbital plate 300 having the included angle α of −15 degrees.

Compared to the included angle α of FIG. 9 (i.e., 30 degrees), the included angles α of FIGS. 18-20 (i.e., 15 degrees, 0 degrees, and −15 degrees) cause the blade connection axis A5 to rise later which results in less time for the blade 104 to clear the workpiece 134 (FIGS. 11A-11C) therefore causing the blade 104 to catch the workpiece 134 on the forward stroke which results in increased vibration. Additionally, when the included angle α is between 0 and −180 degrees, the blade connection axis A5 moves downward during a portion of the forward stroke and increases the vibration felt by the user. For instance, as shown in FIG. 20, the blade connection axis A5 continues to move downward after the BDC position (i.e., at 180 degrees) until P1, which is located at 195 degrees (i.e., −15 degrees). Also, varying the included angle α to be less than 30 degrees may cause the tooth plane Y2 to overshoot the cutting plane Y3 since the blade 104 is being lifted later, which results in less contact time between the tooth plane Y2 and the cutting plane Y3 and therefore increases the average duration of the cut.

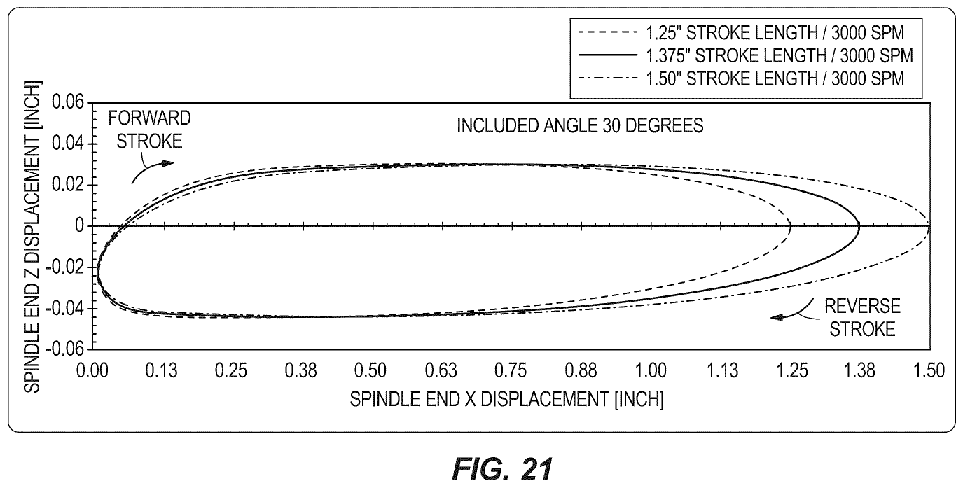

FIG. 21 illustrates the displacement of the blade connection axis A5 for a full 360-degree rotation of the orbital plate 300 about the intermediate shaft axis A4 for the saw 100 having the stroke length of 1.25 inches (FIG. 9), a stroke length of 1.375 inches, and a stroke length of 1.5 inches. To vary the stroke length, the distance X6 may be adjusted. For a stroke length of the 1.25 inches, the distance X6 is 0.625 inches. For a stroke length of 1.375 inches, the distance X6 is 0.6875 inches. For a stroke length of 1.5 inches, the distance X6 is 0.75 inches. Increasing the stoke length and maintaining the operating speed will improve the performance of the tool. Specifically, the mechanical work (e.g., W(t)) done by an object is a product of cutting forces (e.g., F(t)) and blade displacement (e.g., d) in the direction that the blade teeth are oriented. The blade displacement d is dependent on an angle (e.g., θ) which depends on time (e.g., (t)). As such, W(t)=F(t)·d(θ(t)). If the stroke length is increased, the blade is displaced more (i.e., the blade displacement d increases) and the mechanical work therefore increases. The mechanical power (e.g., P(t)) is the rate at which work is done and can be expressed as the time derivative of the mechanical work. As such,

$$P ( t ) = \frac{d}{dt} W ( t ) .$$

When the mechanical work and the mechanical power equations are combined, it reveals that the mechanical power (e.g., P(t)) is a function of cutting forces (e.g., F(t)) and velocity (e.g., Vₓ). As such, P(t)=F(t)·Vₓ.

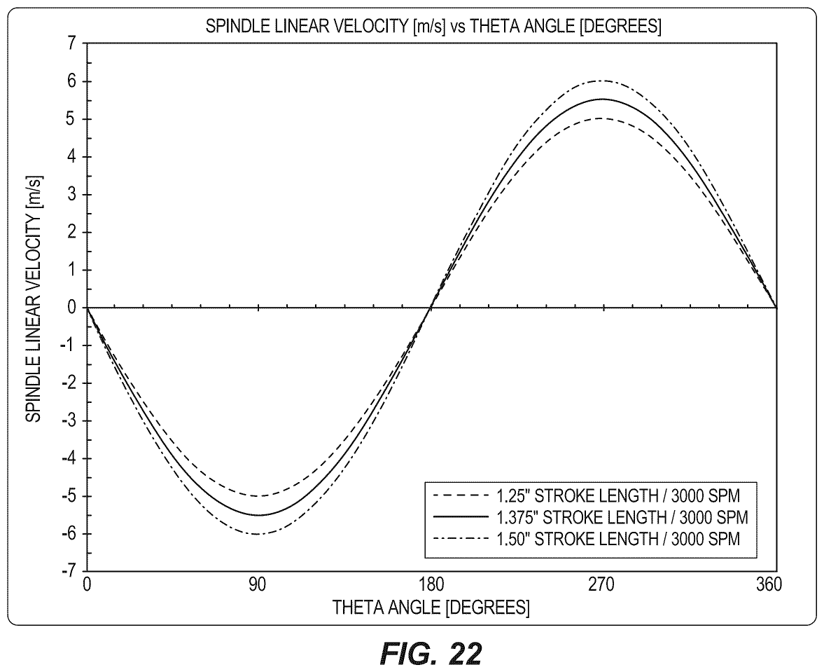

FIG. 22 illustrates the spindle linear velocity of the saw 100 using the orbital plate 300 having the stroke length of 1.25 inches, the stroke length of 1.375 inches, and the stroke length of 1.5 inches. For this study, the motor 112 was set to a constant speed for each of the different stroke lengths such that there was a constant reciprocating speed (stroke/min or SPM). In other words, the only variable being changed was the stroke length (e.g., the distance X6). As shown in the graph of FIG. 22, the greatest magnitude of velocity was approximately 6 m/s and was performed by the saw 100 with the 1.5 inch stroke length. The next highest magnitude of velocity was approximately 5.5 m/s and was performed by the 1.375 inch stroke length. The highest magnitude of velocity for the 1.25 inch stroke length was approximately 5 m/s.

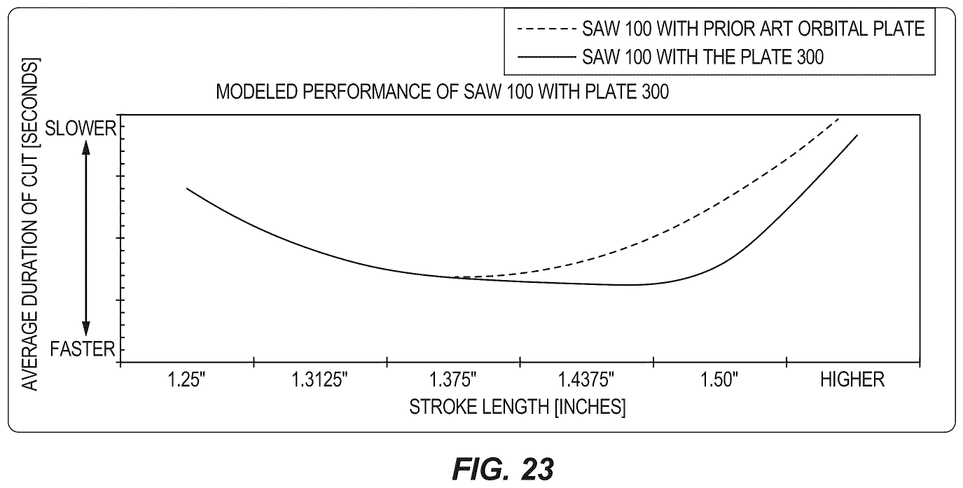

FIG. 23 models the average duration of cut time of the saw 100 with the orbital plate 300 in the solid line with variable stroke lengths. As shown in FIG. 23, the cutting time of the saw 100 with the orbital plate 300 decreases when increasing the stroke length to approximately 1.5 inches. The decrease in cutting time can be attributed to the increased stroke length increasing the blade velocity and/or the increased cut forces due to the increased mechanical work from the increased stroke length. However, when increasing the stroke length past 1.5 inches, the application cut times begin to increase because control of the tool decreases. An example of tool control for the saw 100 includes properly contacting the cutting plane Y3 at the FDC position and maintaining the force F1 downward on the tool. Undershooting or overshooting the cutting plane Y3 contributes to decreased tool control and therefore increased cutting times as discussed earlier in application. For instance, the saw 100 overshoots or undershoots the cutting plane Y3 when moving the stroke length past 1.5 inches thereby increasing the cutting times. In other words, the decreased tool control overpowers the benefits of the increased stroke length (e.g., increased velocity and cutting forces that reduce the cutting time).

FIG. 23 also models the saw 100 with a prior art orbital plate (e.g., the orbital plates 356, 360) in the dotted line with variable stroke lengths. In contrast to the saw 100 with the orbital plate 300 in the solid line, the cutting times for the saw 100 with the prior art orbital plate increases after increasing the stroke length past 1.375 inches due to decreased tool control. The cutting time for the saw 100 with the prior art orbital plates increases (e.g., increasing the stroke length past 1.375 inches) earlier than the saw 100 with the orbital plate 300 (e.g., increasing the stroke length past 1.5 inches) because the prior art orbital plates do not manage the distance X8 of the separation between the planes Y2, Y3 when compared to the orbital plate 300 (FIGS. 11A-11C). In other words, the prior art orbital plate is overshooting or undershooting the cutting plane Y3 thereby decreasing tool control and increasing cut times. In addition to improving the cutting performance of the saw 100 with the orbital plate 300 by increasing the stroke length between 1.25 inches to 1.5 inches, the increased stroke length also improves wear life of the blade 104.

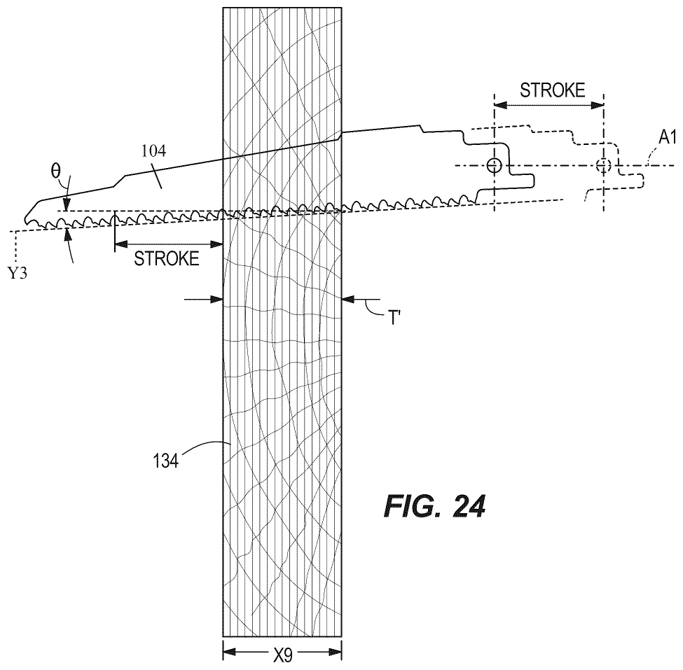

FIG. 24 illustrates the blade 104 of the saw 100 contacting the workpiece 134. The number of activated blade teeth (e.g., ABT) is equivalent to the product of a length of the blade 104 that will receive wear (e.g., WL) and the number of teeth per inch of blade cutting edge (e.g., TPI). As such, ABT=WL. TPI. The length of the blade 104 that will receive wear (e.g., WL) is the sum of the tool stroke length (e.g., Stroke) and the augmented beam thickness from the blade angle (e.g., T′). As such, WL=Stroke+T′. The number of teeth per inch of blade cutting edge (e.g., TPI) is equivalent to the dividend of a number of teeth that share the load (e.g., LS) and the augmented beam thickness from the blade angle (e.g., T′). As such,

$$T P I = \frac{LS}{{T}^{1}} .$$

The augmented beam thickness from the blade angle (e.g., T′) is equivalent to the dividend of a beam thickness (e.g., X9) and the cosine of the blade angle (e.g., θ). As such,

$${T}^{′} = \frac{X 9}{cos ( θ )} .$$

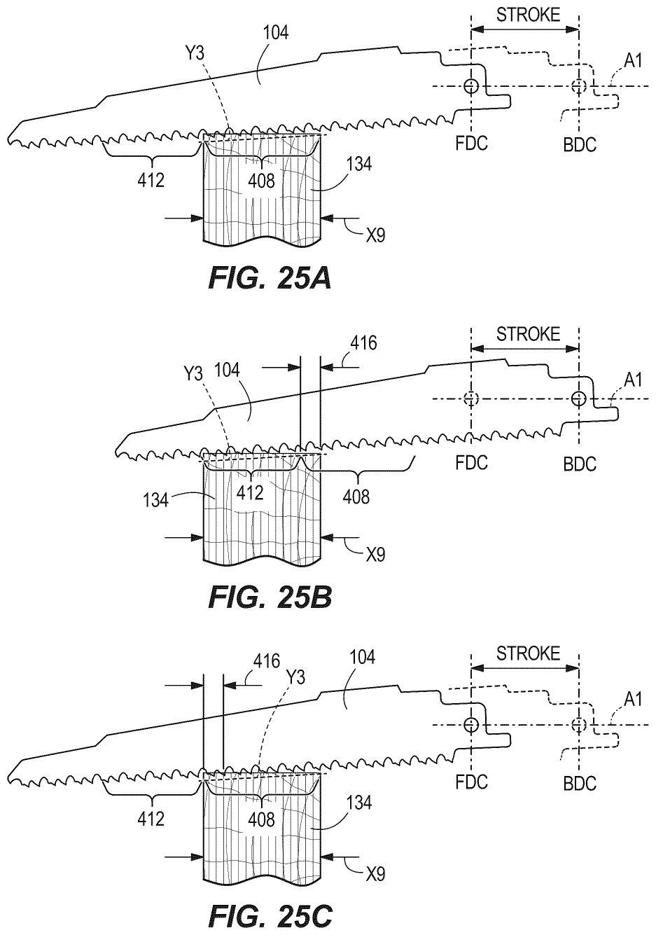

The accumulated wear on the tooth edge of the blade 104 decreases with more activated teeth ABT. The workpiece 134 has the beam thickness X9 as 1.5 inches. The saw 100 in FIGS. 25A-25C has a stroke length of 1.25 inches, the blade angle θ of 0 degrees, and the teeth per inch TPI of 5 (e.g., a AX5TPI blade). As such, the activated teeth ABT is 13.75 teeth per tool stroke. For the saw 100 having the stroke length of 1.375 inches, the blade angle θ of 0 degrees, and the teeth per inch TPI of 5 (e.g., a AX5TPI blade). As such, the activated teeth ABT is 14.75 teeth per tool stroke. The activated teeth ABT increased with an increase in the stroke length, thereby increasing the life of the blade 104 since wear on the tooth is being more evenly distributed along the teeth.

FIGS. 25A-25C illustrate the blade 104 cutting the workpiece 134. In the illustrated construction, the blade 104 is coupled to the saw 100 having a stroke length of 1.25 inches. In the illustrated construction, the beam thickness X9 is 1.5 inches. FIG. 25A illustrates the blade 104 in the FDC position contacting the workpiece 134 before the cut is initiated. A first segment 408 of the blade 104 contacts the entire beam thickness X9. A second segment 412 of the blade 104 represents the portion of the blade 104 that will contact the workpiece 134 as the blade is reciprocated from the FDC position to the BDC position (i.e., reverse stroke).

FIG. 25B illustrates the blade 104 in the BDC position. As mentioned above, the second segment 412 is now in full contact with the workpiece 134. However, since the stroke length is 1.25 inches and the entire beam thickness is 1.5 inches, a third segment 416 of the blade 104 is still in contact with the workpiece 134. In other words, the third segment 416 does not clear the cutting plane Y3 since the saw 100 does not have enough stroke length. The third segment 416 is a portion of the first segment 408 that did not clear the cutting plane Y3. Since the third segment 416 does not clear the cutting plane Y3, the chips developed from the reverse stroke that are disposed in the third segment 416 are not ejected because the third segment 416 does not clear the cutting plane Y3. The chips that occupy the third segment 416 reduce the performance of the third segment 416 of the blade 104 in subsequent strokes.

FIG. 25C illustrates the blade 104 returning to the FDC position from the BDC position after a forward stroke. The first segment 408 resumes full contact with the cutting plane Y3. The second segment 412 fully clears the cutting plane Y3. The third segment 416 remains in contact with the cutting plane Y3, thereby preventing chips in the third segment 416 from being ejected.

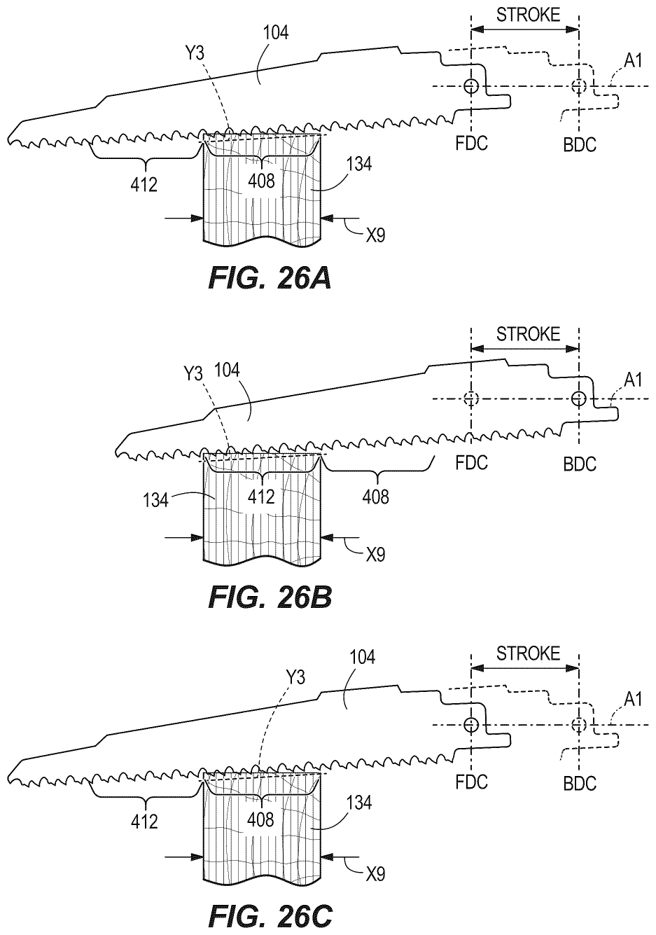

FIGS. 26A-26C illustrate the blade 104 cutting the workpiece 134. In the illustrated construction, the blade 104 is coupled to the saw 100 having a stroke length of 1.5 inches. In the illustrated construction, the beam thickness X9 is 1.5 inches. FIG. 26A illustrates the blade 104 in the FDC position contacting the workpiece 134 before the cut is initiated. FIG. 26B illustrates the blade 104 in the BDC. That is, the saw completed a reverse stroke from FIG. 26A to FIG. 26B. Since the stroke length matches or exceeds the beam thickness X9, the first segment 408 entirely clears the cutting plane Y3. As such, the chips that accumulated in the first segment 408 are ejected due to first segment 408 clearing the cutting plane Y3. FIG. 26C illustrates the blade 104 returning to the FDC position from the BDC position after a forward stroke. Ejecting the chips from the first segment 408 prevents reduced performance caused by chips trapped in the first segment 408 (e.g., the third segment 416 in FIGS. 25B and 25C).

Various features of the invention are set forth in the following claims.

1. A reciprocating saw comprising:
a housing;
an electric motor positioned within the housing and having a motor output shaft rotatable about a motor axis;
a spindle assembly including
a spindle frame pivotably coupled to the housing about a pivot joint, the pivot joint defining a pivot axis, and
a spindle supported for reciprocation within the spindle frame along a spindle axis oriented perpendicular to the pivot axis, wherein the spindle reciprocates between a back-dead-center (BDC) position to a front-dead-center (FDC) position along the spindle axis, the spindle including a blade connection portion configured to secure a saw blade, the blade connection portion defining a blade connection axis parallel to the pivot axis;
an orbital plate configured to convert torque from the motor output shaft to reciprocating movement of the spindle, the orbital plate including a cam surface surrounding a rotational axis of the orbital plate;
an eccentric drive member coupled to the orbital plate for co-rotation therewith, the eccentric drive member having an eccentric portion offset from the rotational axis of the orbital plate, the eccentric portion being coupled to the spindle to impart reciprocating movement thereto in response to rotation of the eccentric drive member and the orbital plate; and
a follower coupled to the spindle assembly and engaged with the cam surface on the orbital plate to pivot the spindle frame about the pivot axis in response to rotation of the orbital plate, thereby imparting an orbital motion to the spindle,
wherein the cam surface includes a high frequency segment occupying less than 180 degrees of a circumference of the cam surface,
wherein a displacement of the blade connection axis in a direction perpendicular to the spindle axis is zero when the spindle is at the FDC position,
wherein a total displacement of the blade connection axis in the direction perpendicular to the spindle axis occurs during a forward stroke when the spindle is traveling from the BDC position to the FDC position, and a reverse stroke when the spindle is traveling from the FDC position to the BDC position, and
wherein the high frequency segment is configured to displace the blade connection axis between 80% to 100% of the total displacement.

2. The reciprocating saw of claim 1, wherein the high frequency segment occupies 90 degrees of a circumference of the cam surface.

3. The reciprocating saw of claim 1, wherein the spindle assembly includes a first bushing configured to support the spindle for reciprocation and a second bushing configured to support the spindle for reciprocation, wherein the spindle frame receives the first and second bushing, and wherein the spindle frame is a single piece.

4. The reciprocating saw of claim 1, further comprising a counterweight, wherein the counterweight is configured to reciprocate a direction parallel to the spindle axis.

5. The reciprocating saw of claim 1, wherein a phase angle of the cam surface at the FDC position is 0 degrees, wherein the phase angle of the cam surface at the BDC position is 180 degrees, wherein the high frequency segment occupies the circumference of the cam surface between a first point and a second point on the cam surface, wherein the phase angle of the cam surface when the follower engages the first point is 150 degrees.

6. A reciprocating saw comprising:
a housing;
an electric motor positioned within the housing and having a motor output shaft rotatable about a motor axis;
a spindle assembly including
a spindle frame pivotably coupled to the housing about a pivot joint, the pivot joint defining a pivot axis, and
a spindle supported for reciprocation within the spindle frame along a spindle axis oriented perpendicular to the pivot axis, wherein the spindle reciprocates between a back-dead-center (BDC) position to a front-dead-center (FDC) position along the spindle axis;
an orbital plate configured to convert torque from the motor output shaft to reciprocating movement of the spindle, the orbital plate including a cam surface surrounding a rotational axis of the orbital plate;
an eccentric drive member coupled to the orbital plate for co-rotation therewith, the eccentric drive member having an eccentric portion offset from the rotational axis of the orbital plate, the eccentric portion having an eccentric pin being coupled to the spindle to impart reciprocating movement thereto in response to rotation of the eccentric drive member and the orbital plate; and
a follower coupled to the spindle assembly and engaged with the cam surface on the orbital plate to pivot the spindle frame about the pivot axis in response to rotation of the orbital plate, thereby imparting an orbital motion to the spindle;
wherein the cam surface includes a high frequency segment spanning a circumference of the cam surface between a first point and a second point,
wherein the cam surface includes a low frequency segment spanning a remainder of the circumference of the cam surface,
wherein the spindle defines a forward stroke when moving from the BDC position to the FDC position,
wherein the spindle defines a reverse stroke when moving from the FDC position to the BDC position, and
wherein at a first rotational position of the orbital plate, the follower engages the first point, and
wherein the eccentric pin is angularly offset from the first point at an included angle between-180 and 180 degrees relative to the rotational axis at the first rotational position.

7. The reciprocating saw of claim 6, wherein the included angle is 30 degrees.

8. The reciprocating saw of claim 6, herein the spindle assembly includes a first bushing configured to support the spindle for reciprocation and a second bushing configured to support the spindle for reciprocation, wherein the spindle frame receives the first and second bushing, and wherein the spindle frame is a single piece.

9. The reciprocating saw of claim 6, further comprising a counterweight.

10. The reciprocating saw of claim 9, wherein the counterweight is configured to reciprocate a direction parallel to the spindle axis.

11. A reciprocating saw comprising:
a housing;
an electric motor positioned within the housing and having a motor output shaft rotatable about a motor axis;
a spindle assembly including
a spindle frame pivotably coupled to the housing about a pivot joint, the pivot joint defining a pivot axis, and
a spindle supported for reciprocation within the spindle frame along a spindle axis oriented perpendicular to the pivot axis;
a transmission member configured to receive torque from the motor output shaft, causing the transmission member to rotate about a rotational axis;
an eccentric drive member coupled to the transmission member for co-rotation therewith, the eccentric drive member having an eccentric portion offset from the rotational axis of the transmission member, the eccentric portion being coupled to the spindle to impart reciprocating movement thereto in response to rotation of the eccentric drive member and the transmission member about the rotational axis;
a cam surface surrounding the rotational axis of the transmission member; and
a follower coupled to the spindle assembly and engaged with the cam surface to pivot the spindle frame about the pivot axis in response to rotation of the cam surface about the rotational axis, thereby imparting an orbital motion to the spindle,
wherein the cam surface includes a first segment and a second segment, the first segment having a first waveform and the second segment having a second waveform that is different from the first waveform.

12. The reciprocating saw of claim 11, wherein the first segment defines a first angular span, wherein the second segment defines a second angular span, wherein the first angular span is less than the second angular span.

13. The reciprocating saw of claim 12, wherein the first angular span is 90 degrees.

14. The reciprocating saw of claim 12, wherein the spindle reciprocates between a back-dead-center (BDC) position to a front-dead-center (FDC) position along the spindle axis, wherein the spindle includes a blade connection portion configured to secure a saw blade, the blade connection portion defining a blade connection axis parallel to the pivot axis, wherein a displacement of the blade connection axis relative in a direction perpendicular to the spindle axis is zero when the spindle is at the FDC position, wherein a phase angle of the cam surface at the FDC position is 0 degrees, wherein the phase angle of the cam surface at the BDC position is 180 degrees.

15. The reciprocating saw of claim 14, wherein the blade connection axis moves in a first direction perpendicular to the spindle axis in a reverse stroke when the spindle is traveling from the FDC position to the BDC position, wherein a reverse maximum displacement of the blade connection axis in the first direction occurs when the phase angle is 150 degrees.

16. The reciprocating saw of claim 15, wherein the blade connection axis moves in a second direction perpendicular to the spindle axis in a forward stroke when the spindle is traveling from the BDC position to the FDC position, the second direction being opposite from the first direction, wherein a forward maximum displacement the second direction occurs when the phase angle is 240 degrees.

17. The reciprocating saw of claim 11, herein the spindle assembly includes a first bushing configured to support the spindle for reciprocation and a second bushing configured to support the spindle for reciprocation, wherein the spindle frame receives the first and second bushing, and wherein the spindle frame is a single piece.

18. The reciprocating saw of claim 11, further comprising a counterweight.

19. The reciprocating saw of claim 18, wherein the counterweight is configured to reciprocate a direction parallel to the spindle axis.

20. The reciprocating saw of claim 11, wherein the reciprocating saw includes a drive pinion coupled for co-rotation with the motor output shaft, wherein the transmission member is meshed with the drive pinion.

21. The reciprocating saw of claim 11, wherein the transmission member is rotatably supported by an intermediate shaft coaxial with the rotational axis.

22. The reciprocating saw of claim 11, wherein the rotational axis is perpendicular to the motor axis.

23. The reciprocating saw of claim 11, wherein the follower is a roller bearing supported at a rear end of the spindle frame.

24. The reciprocating saw of claim 11, further comprising a biasing member positioned between the spindle frame and the housing, the biasing member configured to impart a restoring moment about the pivot axis.

25.-40. (canceled)
